(19) United States
(12) Patent Application Publication
(10) Pub. No.: US 2022/0198593 A1
(43) Pub. Date: Jun. 23, 2022

(54) SYSTEMS AND METHODS OF DYNAMIC GRAPHICAL USER INTERFACES FOR RESOURCE POOL ALLOCATION

(71) Applicant: ROYAL BANK OF CANADA, Toronto (CA)

(72) Inventors: Nigel FAWCETT, Toronto (CA); Leanne KAUFMAN, Toronto (CA); Nicole BACCHUS, Toronto (CA); Charlene LEUNG, Toronto (CA); Joseph GUIYAB, Toronto (CA); Edwardette TAGOE, Toronto (CA); Marisa PORRECA, Toronto (CA); Stephanie COLLINS, Toronto (CA); Pauline SAVOY, Toronto (CA); Sayuri KAGAMI, Toronto (CA); Daryl LINDSAY, Toronto (CA); Felicia ROUTHIER, Toronto (CA); Nada YOUNIS, Toronto (CA); Melanie POULIN, Toronto (CA); Michelle KASPER, Toronto (CA); Ann MATSCHKE, Toronto (CA); Tracey WOO, Toronto (CA)

(21) Appl. No.: 17/561,215

(22) Filed: Dec. 23, 2021

Related U.S. Application Data
(60) Provisional application No. 63/130,043, filed on Dec. 23, 2020.

(51) Int. Cl. G06Q 50/18; G06F 3/0482

(52) U.S. Cl. CPC G06Q 50/186; G06F 3/0482

(57) ABSTRACT

Systems and methods for dynamic generation of successive user interfaces. A system may include a processor and a memory. The memory may store processor-executable instructions that, when executed, configure the processor to: retrieve a series of user inputs corresponding to one or more attributes associated with one or more resources; generate a complexity prediction associated with resource allocation based on an allocation model and the one or more attributes, the allocation model defined by complexity scores associated with respective attributes; in response to the respectively retrieved user inputs, generate an update to a user interface element representing progress with allocating the one or more resources to a user identifier, wherein at least one user interface element is based on the generated complexity prediction; and transmit a signal for communicating the user interface element update to a display device displaying progressive action status for allocating the one or more resources.

### CROSS REFERENCE TO RELATED APPLICATIONS

This application claims priority from U.S. provisional patent application No. 63/130,043, entitled “SYSTEMS AND METHODS OF DYNAMIC ALLOCATION OF DIGITAL ESTATES”, filed on Dec. 23, 2020, the entire contents of which are hereby incorporated by reference herein.

### FIELD

Embodiments of the present disclosure generally relate to resource allocation, and in particular to systems and methods of dynamic user interfaces for resource pool allocation.

### BACKGROUND

Computing servers may allocate resources to an entity associated with one or more client devices. Resources may include assets (e.g., tokens, currency, precious metals, real estate, among other examples), and assets may be associated with personal assets, business assets, or other types of assets associated with users.

Resource pool distribution may include allocating resource assets to one or more user identifiers according to an administrative framework. As a non-limiting example, the administrative framework may be processes, conventions, or rules associated with estate settlement. An executor user of an estate may be designated to allocate resource assets of a deceased user to one or more beneficiary users, and may otherwise conduct operations for carrying out resource distributions on behalf of a deceased user. Such resource pool distribution may be applicable with other types of administrative framework.

### SUMMARY

Embodiments of systems and methods for dynamically generating user interfaces associated with resource pool allocation operations are described in the present disclosure. For ease of exposition, embodiments of systems and methods may be described in the context of dynamically generating user interfaces associated with estate settlements (e.g., a type of administrative framework). Further, embodiments of systems and methods may be configured for dynamically generating user interfaces associated with allocating resource pools according to other administrative frameworks.

In some scenarios, an administrative framework for resource pool allocation may be multifaceted, and successive resource allocations may be based on complex rules or procedural operations. In an estate settlement scenario, an executor user may conduct a plurality of operations for carrying out final wishes of a deceased user. The executor user may conduct operations for distributing resource pools or assets to one or more beneficiary users. Such example operations may be based on contingent rules or procedural requirements. For instance, executor users may need to transmit letters or forms prior to allocating resource pools or assets to one or more beneficiary users. There may be formal or strict requirements for such letters or forms, which may be governed by administrative frameworks. Embodiments of systems and methods described in the present disclosure are directed to dynamically generating user interfaces associated with resource pool allocations.

In some embodiments, systems and methods may be configured to provide complexity predictions associated with resource pool distributions, thereby providing a personalized digital experience for executor users conducting estate settlement operations. In some embodiments, the systems and methods may provide user interfaces at a client device, thereby providing estate settlement guidance/information to executor users. The estate settlement guidance/information may be associated with types of resource assets, the nature of estate settlements, or beneficiary types, among other examples.

In some embodiments, the systems and methods may be configured to dynamically generate graphical user interfaces for providing such estate settlement complexity predictions. The graphical user interfaces may be searchable and accessible web pages via the Internet, and may provide prospective executor users with a front-end digital resource. The front-end digital resource may include features for establishing a communication channel with estate settlement services offered via a financial institution system.

In some embodiments, the systems and methods may be configured to dynamically generate user interfaces based on prior determined complexity predictions. Dynamically generated user interfaces that may be based on prior determined complexity predictions may reduce the volume or complexity of generated user interfaces for displaying letters, forms, or other guiding collateral for the executor user.

In some embodiments, the systems and methods may be configured to identify a complexity prediction associated with allocating a particular resource type. In a scenario where the complexity prediction value may be relatively high and beyond a threshold value, the system may be configured to generate a distinguishable set of user interface elements based on the nature of the resources to be allocated. As an example, for non-standard resources that may not be within the administrative aptitude of an ordinary executor user, the system may be configured to update user interface elements for providing guidance on engaging a service provider (e.g., an estate trustee, or other professional user) to assist with complex disposition or allocation of assets. Examples will be described herein.

In some embodiments, based on a complexity prediction, systems may be configured to recommend assistance of an estate professional user, in which case user input and data elements gathered or derived to date may be packaged and communicated to the estate professional user or group for further advice and handling.

In one aspect, the present disclosure provides a system for dynamic generation of successive user interfaces. The system may include: a processor; and a memory coupled to the processor. The memory may store processor-executable instructions that, when executed, configure the processor to: retrieve a series of user inputs corresponding to one or more attributes associated with one or more resources; generate a complexity prediction associated with resource allocation based on an allocation model and the one or more attributes, the allocation model defined by complexity scores associated with respective attributes; in response to the respectively retrieved user inputs, generate an update to a user interface element representing progress with allocating the one or more resources to a user identifier, wherein at least one user interface element is based on the generated complexity prediction; and transmit a signal for communicating the user interface element update to a display device displaying progressive action status for allocating the one or more resources.

In another aspect, the present disclosure provides a method for dynamic generation of successive user interfaces. The method may include: retrieving a series of user inputs corresponding to one or more attributes associated with one or more resources; generating a complexity prediction associated with resource allocation based on an allocation model and the one or more attributes, the allocation model defined by complexity scores associated with respective attributes; in response to the respectively retrieved user inputs, generating an update to a user interface element representing progress with allocating the one or more resources to a user identifier, wherein at least one user interface element is based on the generated complexity prediction; and transmitting a signal for communicating the user interface element update to a display device displaying progressive action status for allocating the one or more resources.

In another aspect, a non-transitory computer-readable medium or media having stored thereon machine interpretable instructions which, when executed by a processor may cause the processor to perform one or more methods described herein.

In various aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system, in accordance with an embodiment of the present disclosure;

FIG. 2 illustrates a graphical user interface associated with a questionnaire form, in accordance with an embodiment of the present disclosure;

FIG. 3 illustrates a graphical user interface associated with a questionnaire form, in accordance with an embodiment of the present disclosure;

FIG. 4 illustrates a graphical user interface associated with a questionnaire form, in accordance with an embodiment of the present disclosure;

FIG. 5 illustrates a graphical user interface associated with a questionnaire form, in accordance with an embodiment of the present disclosure;

FIG. 6 illustrates a graphical user interface associated with a questionnaire form, in accordance with an embodiment of the present disclosure;

FIG. 7 illustrates a graphical user interface associated with a questionnaire form, in accordance with an embodiment of the present disclosure;

FIG. 8 illustrates a flowchart of a method of resource pool allocation, in accordance with an embodiment of the present disclosure;

FIG. 9 illustrates a graphical user interface associated with a questionnaire form, in accordance with an embodiment of the present disclosure;

FIG. 10 illustrates a graphical user interface, in accordance with an embodiment of the present disclosure;

FIG. 11 illustrates a graphical user interface, in accordance with an embodiment of the present disclosure;

FIG. 12 illustrates a graphical user interface, in accordance with an embodiment of the present disclosure;

FIG. 13 illustrates a graphical user interface, in accordance with an embodiment of the present disclosure;

FIG. 14 illustrates a graphical user interface, in accordance with an embodiment of the present disclosure;

FIG. 15 illustrates a graphical user interface, in accordance with an embodiment of the present disclosure;

FIG. 16 illustrates a graphical user interface, in accordance with an embodiment of the present disclosure;

FIG. 17 illustrates a graphical user interface, in accordance with an embodiment of the present disclosure;

FIGS. 18 and 19 illustrate graphical user interfaces, in accordance with embodiments of the present disclosure;

FIG. 20 illustrates a graphical user interface, in accordance with an embodiment of the present disclosure;

FIG. 21 illustrates a graphical user interface, in accordance with an embodiment of the present disclosure;

FIG. 22 illustrates a graphical user interface, in accordance with an embodiment of the present disclosure;

FIGS. 23 and 24 illustrate graphical user interfaces, in accordance with embodiments of the present disclosure;

FIGS. 25 and 26 illustrate graphical user interfaces, in accordance with embodiments of the present disclosure;

FIG. 27 illustrates a graphical user interface, in accordance with an embodiment of the present disclosure; and

FIG. 28 illustrates a flowchart of a method of dynamic generation of successive user interfaces, in accordance with embodiments of the present disclosure.

### DETAILED DESCRIPTION

Embodiments of systems and methods for dynamically generating user interfaces associated with resource pool operations are described in the present disclosure. For ease of exposition, embodiments of systems and methods are described in the context of dynamically generating user interfaces associated with estate settlements (e.g., a type of administrative framework). Embodiments of systems and methods may be configured for dynamically generating user interfaces for other types of administrative frame works.

In an example estate settlement scenario, the administrative framework for resource pool allocation may be multifaceted, and successive resource allocations may be based on one or more dependencies on rules or procedural operations. For example, operations for allocating resources or assets to beneficiary users may be dependent on asset types (e.g., real estate assets, liquid assets, business or personal assets, liabilities or debts, among other examples), location of beneficiary users, among other rules. In some scenarios, administrative frameworks may prescribe strict timelines for conducting administrative procedures prior allocating resource pools or assets, among other administrative framework requirements.

As operations governed by administrative frameworks may result in a plurality of possible paths or outcomes, it may be beneficial to provide systems and methods of dynamically generating user interfaces associated with resource pool allocations directed by administrative frameworks. As display screens of computing devices associated with executor users may have limited surface area (e.g., display real estate), embodiments of systems and methods described in the present disclosure may reduce the volume of user interface elements for display at display screens, and such user interface elements may be determined to be applicable for the relevant path or outcome as governed by a relevant administrative framework.

For ease of exposition, embodiments of the systems and methods described herein may be configured as a digital, self-serve estate settlement system for enabling executor users with dynamically generated user interfaces pertinent to the estate settlement process for a particular deceased user.

An administrative framework may include processes, conventions, or rules associated with estate settlements. An executor user of an estate may be designated to allocate resource assets of a deceased user to one or more beneficiary users, and may otherwise conduct operations for carrying out resource distributions on behalf of a deceased user. In some embodiments, resources may include assets (e.g., tokens, currency, precious metals, real estate, among other examples).

In some scenarios, estate settlement may be associated with a plurality of operations having varying degrees of complexity. Complexity of estate settlement may be based on at least one of: physical location of executor user relative to deceased user, nature of resource assets, presence of a most recent will or last testament of a deceased user (e.g., a data set identifying wishes of the deceased individual regarding distribution of resource assets), or details associated with one or more beneficiary users, among other examples.

To illustrate embodiments of the present disclosure, example banking institution systems and methods may be described. In the context of banking institution systems, resource allocations may include disbursing monetary assets, real estate assets, or other resource assets associated with a deceased user. Resource allocations may be associated with a wealth management group of a banking institution system, and the resource allocations may be associated with assets associated with banking accounts or other accounts of a deceased user.

In some examples, estate settlement operations may include determining beneficiary user relationships to the deceased user, determining inventory of the resource assets of the deceased user, valuating the resource assets of the deceased user, or distributing the resource assets of the deceased user to one or more beneficiary users, among other examples.

It may be beneficial to provide systems and methods for providing complexity predictions associated with resource pool allocation, thereby providing a personalized digital experience for executor users conducting estate settlement operations. In some scenarios, it may be desirable to generate signals for displaying user interfaces for providing estate settlement guidance to the executor user at a client device based on received data sets associated with estate settlement. Dynamically generated user interfaces may be based on complexity predictions identified based on data sets representing a deceased user's resource pool of assets.

In some embodiments, systems and methods may be configured to generate user interfaces for providing an estate information questionnaire. The system may be configured to receive signals representing executor user input regarding a deceased user's estate. The system may be configured to generate data sets based on the executor user input and may be configured to generate complexity predictions based on the generated data sets. In some embodiments, the system may be configured to dynamically generate downstream user interfaces based on the complexity predictions.

In some embodiments, systems and methods may be configured to generate dynamic dashboard user interfaces for representing summary information based on data sets representing the estate, thereby assisting estate users with an estate settlement process. In some embodiments, dashboard user interfaces may include progress tracking user interface elements, including visual indicators for users to understand a completion status of discrete tasks associated with the estate settlement process.

In some embodiments, the dashboard user interfaces may include dynamic executor user checklists personalized based on the prior data sets representing the estate. The dynamically generated checklists may be generated to provide pertinent fields and display elements, so as to maximize usage of a display device having limited display real estate. In some embodiments, the dashboard user interfaces may include dynamically generated estate status reports for outlining completion progress for estate settlement operations.

In some embodiments, the systems and methods may be configured to generate user interfaces representing documents associated with operations governed by a relevant administrative framework. For example, for estate settlement operations, user interfaces may include dynamically populated forms, letters, or other communications based on the data sets representing the subject estate. In some embodiments, the contents of the dynamically populated forms, letters, or other interfaces may be based on complexity predictions determined based on the data sets representing the subject estate. For example, dynamically populated forms or letters may include further detail or additional data fields in the scenario where an estate is identified as being associated with high complexity.

In some embodiments, based on a complexity prediction, systems may be configured to generate a signal representing recommended assistance of an estate professional user, in which case user input and data elements gathered or derived to date may be packaged and communicated to the estate professional user or group for further advice and handling.

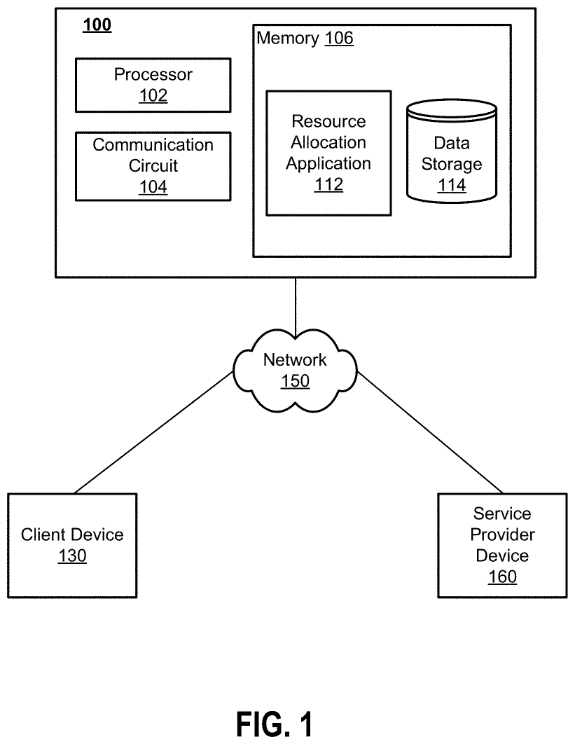

Reference is made to FIG. 1, which illustrates a system 100, in accordance with an embodiment of the present disclosure. The system 100 may, via a network 150, transmit or receive data messages to/from a client device 130 or a service provider device 160.

In some embodiments, the system 100 may be associated with a banking institution, or any other institution associated with estate settlement or estate administration operations. The client device 130 may be associated with an executor user and the service provider device 160 may be associated with a user who may provide estates administration services. In some examples, estates administration services may be related to banking institution services related to investing estate assets or transferring monetary assets from a deceased user's account to a beneficiary user's account, among other examples.

In some embodiments, the system 100 may be configured to generate signals for displaying guidance relating to estate settlement on a user interface at the client device 130. For example, such guidance may be provide personalized resources or tools to an executor user associated with the client device 130.

In some embodiments, the system 100 may be configured to generate complexity predictions associated with estate settlement based on received user input from the client device 130. For example, the received user input may be based on a questionnaire form displayed at the client device 130, and the client device 130 may be configured to generate one or more data sets representing responses to numerous questions associated with an estate of a deceased user. The generated complexity prediction may provide the executor user (associated with the client device 130) with a relative indication on whether it may be advisable to seek assistance of users associated with a service provider device 160 who may have specialized knowledge of estate settlement matters.

The network 150 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be contemplated. In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks.

The system 100 includes a processor 102 configured to implement processor-readable instructions that, when executed, configure the processor 102 to conduct operations described herein. For example, the system 100 may be configured to generate signals for providing user interfaces to one or more client devices 130. In some embodiments, the system 100 may be configured to provide a user interface at the client device 130 for receiving input data sets (e.g., questionnaire responses) associated with a resource pool of a deceased user.

In some embodiments, the system 100 may be configured to generate complexity predictions based on an allocation model and the received input data sets. For example, the complexity predictions may provide an indication of whether estate settlement of resource assets associated with a deceased user may be considered low, medium, or highly complex.

In some embodiments, based on the determined complexity predictions, the system 100 may generate signals for transmitting to the service provider device 160 to indicate that the executor user of the client device 130 may benefit from or require services provided by a user of the service provider device 160.

The processor 102 may be a microprocessor or microcontroller, a digital signal processing processor, an integrated circuit, a field programmable gate array, a reconfigurable processor, or combinations thereof.

The system 100 includes a communication circuit 104 configured to transmit or receive data messages to or from other computing devices, to access or connect to network resources, or to perform other computing applications by connecting to a network (or multiple networks) capable of carrying data. In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store a resource allocation application 112 including processor-readable instructions for conducting operations described herein. In some examples, the resource application 112 may include operations for conducting machine learning operations associated with a recommendation engine for determining a complexity of a proposed estate settlement. The resource allocation application 112 may include operations for dynamically determining complexity of proposed estate settlements based on data sets stored in a data storage 114 representing prior estate settlements. The operations for dynamically determining complexity of proposed estate settlements may be based on machine learning operations over time.

In some embodiments, the data storage 114 may be a secure data store, and may store data records received from one or more client devices 130 (associated with executor users), data records received from one or more service provider devices 160 (associated with service operations of prior estate settlements of other deceased users), or resource asset data of deceased users and that may be associated with the banking institution system 100, among other examples.

The client device 130 or the service provider device 160 may be computing devices, such as mobile smartphone devices, tablet devices, personal computer devices, or thin-client devices, among other examples. The client device 130 or the service provider device 160 may be configured to transmit messages to/from the system 100. FIG. 1 illustrates a single client device 130 and a single service provider device 160; however, any number of client devices or service provider devices may be contemplated.

The client device 130 or the service provider device 160 may include a processor, a memory, or a communication interface, similar to the example processor, memory, or communication interfaces of the system 100.

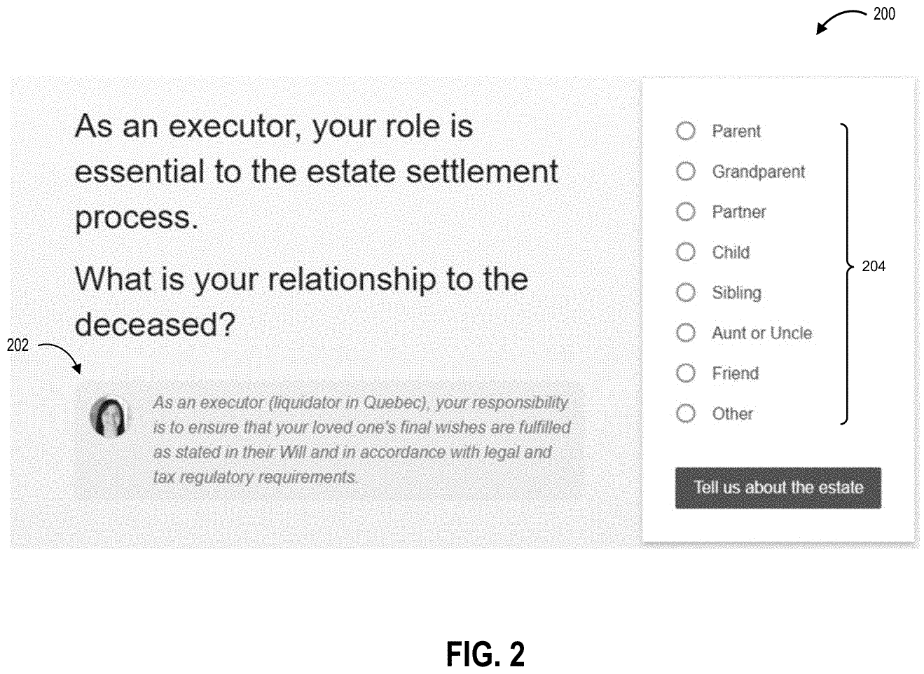

Reference is made to FIG. 2, which illustrates a graphical user interface 200 associated with a questionnaire form, in accordance with an embodiment of the present disclosure. The system 100 (FIG. 1) may generate signals for transmitting and displaying at the client device 130 (FIG. 1) a series of user interfaces configured to receive executor user responses.

In FIG. 2, the graphical user interface 200 may include a text-based region 202 providing estate settlement guidance/information. For example, the estate settlement guidance/information may provide general information relating estate settlement. In FIG. 2, the text-based region 202 may explain in general terms the roles or responsibilities of an executor user.

In FIG. 2, the graphical user interface 200 includes user interface elements 204, such as radio-buttons, for receiving user input for indicating the executor user's relationship to a deceased user. Although radio-button elements are illustrated in FIG. 2, other user interface elements, such as check-box interface elements, toggle switch elements, or text-box input fields, may be contemplated. As will be described herein, the system 100 may receive the user input and may determine complexity predictions associated with an estate settlement based on the combination of user input received across one or more graphical user interfaces.

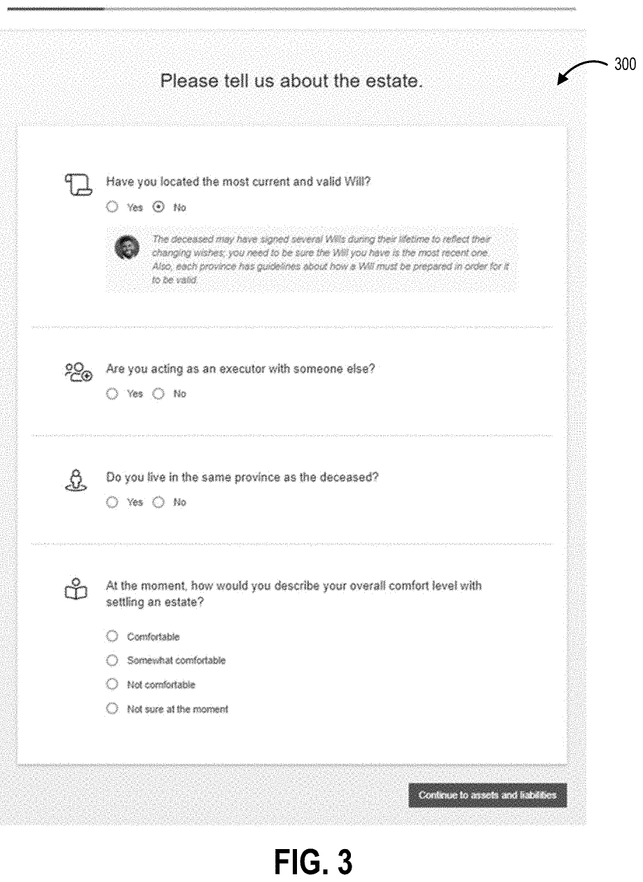

Reference is made to FIG. 3, which illustrates a graphical user interface 300 associated with a questionnaire form, in accordance with an embodiment of the present disclosure. The system 100 (FIG. 1) may generate signals for transmitting and displaying at the client device 130 (FIG. 1) the graphical user interface 300, and the graphical user interface 300 may be configured to receive executor user responses.

In some embodiments, the questionnaire form may include questions such as:
Have you located the most current and valid Will for the deceased user?
Are you acting as an executor with someone else?
Do you live in the same province as the deceased?
At the moment, how would you describe your overall comfort level with settling an estate?
Do you know if the estate involves any of the following assets and liabilities?
   Does the estate contain any real estate (e.g., residential, commercial, farmland, cottage, foreign property, etc.)?
   Are there any liquid assets (e.g., cash, bank accounts, investments, life insurance, foreign assets, etc.)?
   What personal assets exist (e.g., vehicles, art, jewelry, heirlooms, etc.)?
   Are there any digital assets (e.g., cryptocurrency, email, social media accounts, reward/points cards, etc.)?
   Does the estate include any business assets (e.g., private corporation, professional company, such as dental or medical professional corporation, partnership, operating business, etc.)?
   Are there any financial liabilities (e.g., mortgages, loans, credit cards, lines of credit, outstanding income taxes, etc.)?
   Have you identified any beneficiaries that: live outside the province, live outside the country, have a disability and requires support, are minors, will have an inheritance held in a trust, are a registered charitable organization, etc.)?

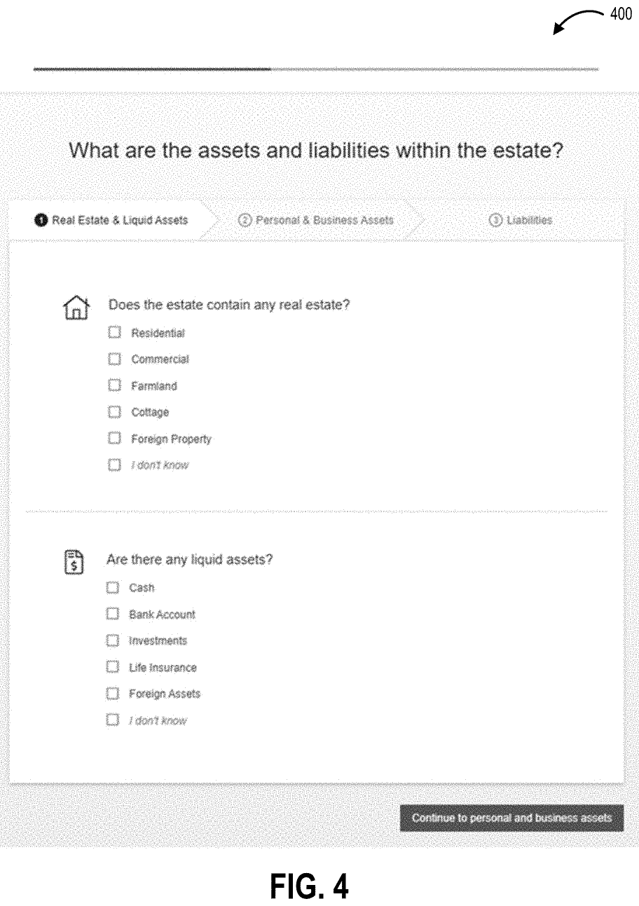

FIG. 4 illustrates a graphical user interface 400 associated with a questionnaire form, in accordance with an embodiment of the present disclosure. In FIG. 4, check-box user interface elements are provided for receiving user input relating to real estate and liquid assets of a deceased user.

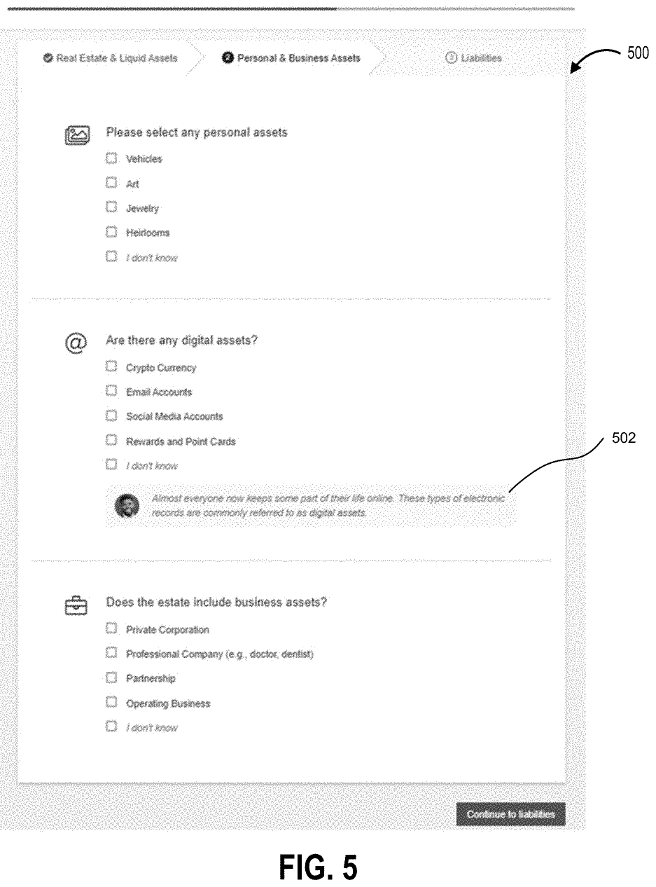

FIG. 5 illustrates a graphical user interface 500 associated with a questionnaire form, in accordance with an embodiment of the present disclosure. In FIG. 5, check-box user interface elements are provided for receiving user input relating to personal or business assets. Further, a text-based region 502 is provided to display estate settlement guidance to an executor user. Although the text-based region 502 is provided for a section regarding “digital assets”, the text-based region may be associated with any one of the plurality of check-box user interface elements.

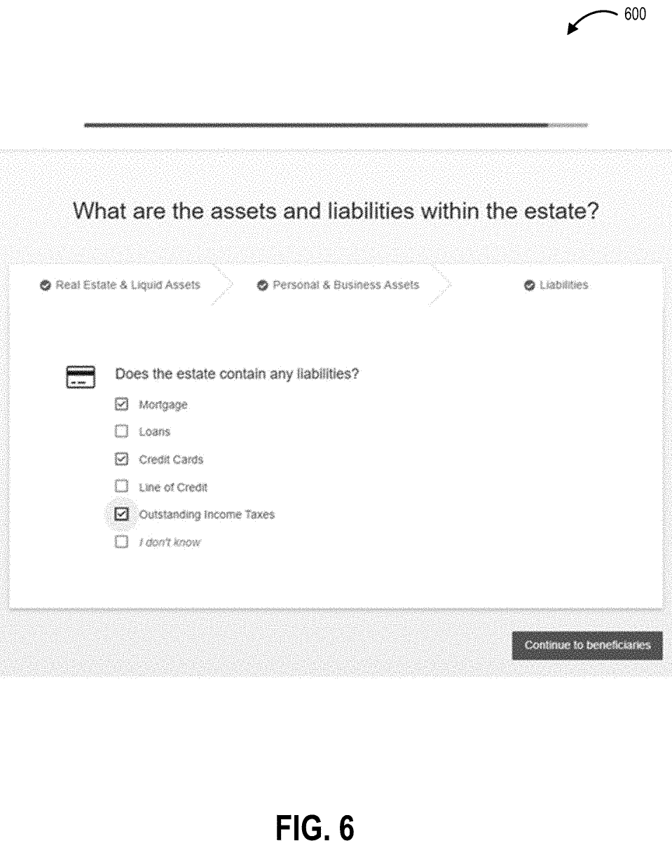

FIG. 6 illustrates a graphical user interface 600 associated with a questionnaire form, in accordance with an embodiment of the present disclosure. In FIG. 6, check-box user interface elements are provided for receiving user input relating to personal or business assets.

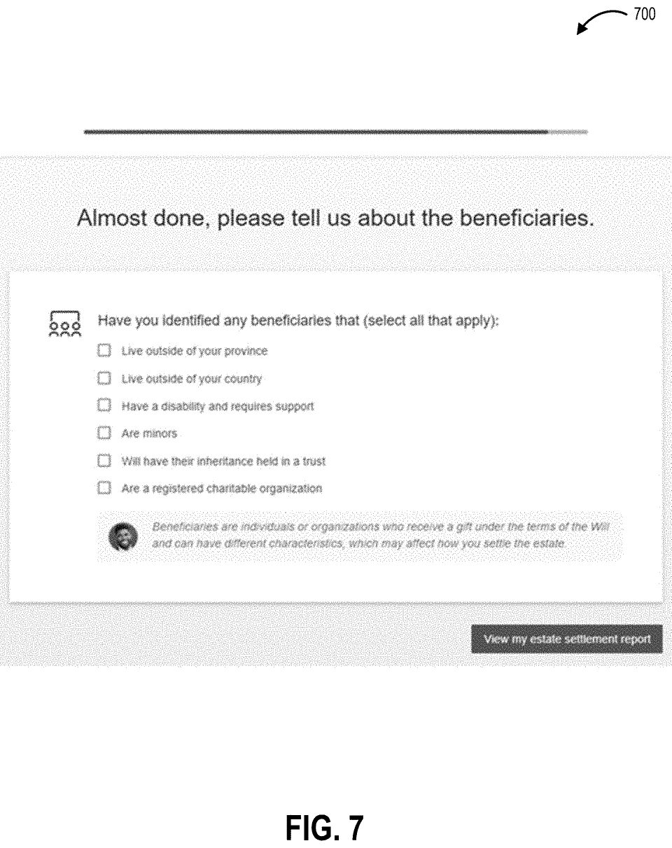

FIG. 7 illustrates a graphical user interface 700 associated with a questionnaire form, in accordance with an embodiment of the present disclosure. In FIG. 7, check-box user interface elements are provided for receiving user input relating to identified beneficiaries of an estate of a deceased user.

Embodiments of the graphical user interfaces illustrated in FIGS. 2 to 7 are non-limiting examples, and other graphical user interfaces including other substantive content or layouts may be contemplated.

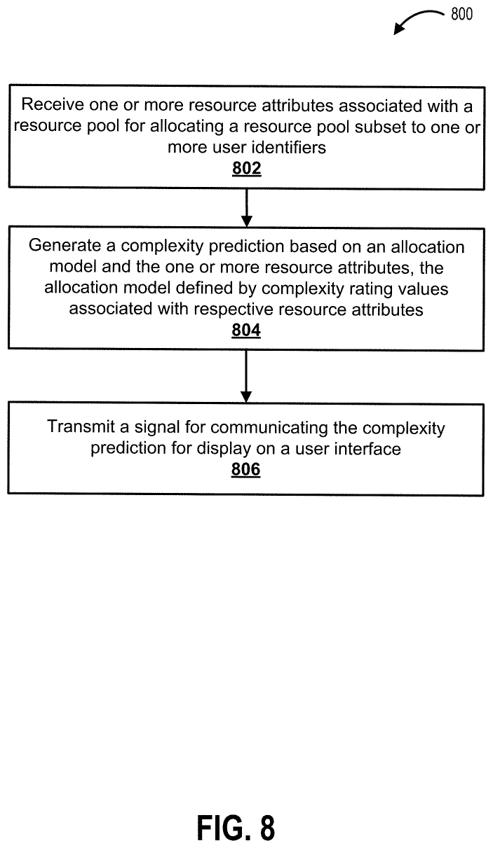

Reference is made to FIG. 8, which illustrates a flowchart of a method 800 of resource pool allocation, in accordance with an embodiment of the present disclosure. The method 800 may be conducted by the processor 102 of the system 100 (FIG. 1). Processor-executable instructions may be stored in the memory 106 and may be associated with the resource allocation application 112 or other processor-executable applications not illustrated in FIG. 1. The method 800 may include operations such as data retrievals, data manipulations, data storage, or other operations, and may include computer-executable operations.

At operation 802, the processor may receive one or more resource attributes associated with a resource pool associated with allocating a resource pool subset to one or more beneficiary user identifiers. For example, the processor may transmit signals to the client device 130 for displaying one or more graphical user interfaces configured to receive user input. The graphical user interfaces may include portions of a questionnaire form. As an illustrating example, portions of a questionnaire form may include those illustrated in any one of the graphical user interfaces in FIGS. 2 to 7.

In some examples, resource attributes may include data indicating types of resource assets that may form part of an estate of a deceased user. In some examples, resource attributes may include data associated with instruments that may define the estate of the deceased user (e.g., latest and valid will of the deceased user, who the beneficiary users are, etc.). In some examples, resource attributes may include data associated with the executor user, whereby details of the executor user may determine, in part, complexity of estate settlement for the deceased user. The processor may receive other resource attributes via graphical user interfaces for generating complexity predictions, generating estate settlement models, or otherwise settling estates of deceased users.

At operation 804, the processor may generate a complexity prediction based on an allocation model and the one or more resource attributes. The allocation model may be defined by complexity rating values associated with respective resource attributes.

In some embodiments, a basis points system may associate complexity rating values with received resource attribute values for determining complexity of an estate settlement. In some embodiments, association of complexity rating values with resource attribute values may be based on historical data sets of prior estate settlements of a plurality of deceased user accounts.

In some embodiments, association of complexity rating values with resource attribute values may be based on machine learning operations, such that the complexity rating values may be dynamically refined based on estate settlement trends over time. For example, complexity of settling estates involving cryptocurrency assets may deemed complex today; however, over time, the complexity of settling estates involving cryptocurrency assets may be deemed to be less complex as legal, regulatory, and procedural requirements are refined over time. Accordingly, rather than conducting static complexity evaluations of proposed estate settlements, systems and methods disclosed herein may dynamically refine complexity rating values over time.

As non-limiting examples, an estate settlement complexity prediction may provide at least one of the following ratings: “Simple”, “Moderate”, or “Complex”, and may be based on a number of accumulated basis points associated with received resource attributes (at operation 802). For example, an estate settlement matter may be identified as “simple complexity” if the aggregate of points is 0 to 15, “moderate complexity” if the aggregate of points is 16 to 30, or “complex” if the aggregate of points is greater than 40 points. Table 1 illustrates an example mapping of received user responses and basis point values in an example system:

TABLE 1

| Resource Attribute/Executor | |
|---|---|
| User Response | Basis Point Value Mapping |
| Have you located the most | No (5) |
| current and valid Will for | Yes (0) |
| the deceased? | |
| Are you acting as an executor | Yes (2) |
| with someone else? | No (0) |
| Do you live in the same | Yes (0) |
| province as the deceased? | No (3) |
| Does the estate contain any | Residential (1) |
| real estate? | Commercial (3) |
| | Farmland (3) |
| | Cottage (2) |
| | Foreign property (4) |
| | I don't know (3) |
| Are there any liquid assets? | Cash(1) |
| | Bank account (1) |
| | Investments (1) |
| | Life insurance (1) |
| | Foreign assets (4) |
| | I don't know (3) |
| Personal Assets | Vehicles (2) |
| | Art (2) |
| | Jewelry (1) |
| | Heirlooms (2) |
| | I don't know (3) |
| Digital Assets | Crypto currency (3) |
| | Email (1) |
| | Social media accounts (1) |
| | Rewards and points cards (1) |
| | I don't know (3) |
| Does the estate include any | Private corporation (4) |
| business assets? | Professional company, e.g., doctor, |
| | dentist (3) |
| | Partnership (3) |
| | Operating business (4) |
| | I don't know (3) |
| Liabilities | Mortgage(2) |
| | Loans (2) |
| | Credit cards (1) |
| | Line of credit (1) |
| | Outstanding income taxes (2) |
| | I don't know (3) |
| Beneficiary users that: | Live outside of your province (1) |
| | Live outside of your country (2) |
| | May have a disability and requires |
| | support (2) |
| | Are minors (1) |
| | Will have their inheritance held in a |
| | trust (3) |
| | Are a registered Charitable |
| | Organization (2) |

Mappings of basis point values to resource attributes in Table 1 are examples only, and other mappings may be contemplated.

In some embodiments, the processor may generate and dynamically update the allocation model based on data sets representing prior estate settlements. For example, the allocation model may be based on data sets stored at the data storage 114, representing results of prior estate settlements, such that complexity ratings may be deduced.

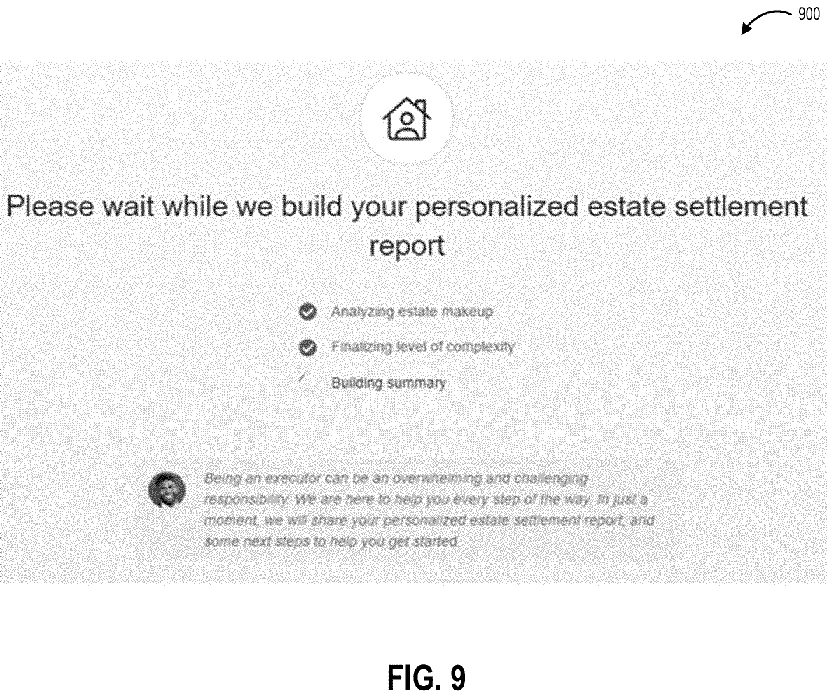

To illustrate, reference is made to FIG. 9, which illustrates a graphical user interface 900, in accordance with an embodiment of the present disclosure. The graphical user interface 900 may be a dynamic user interface that is transmitted to and displayed at the client device 130 during operation 804, during computation of a complexity prediction.

Referring again to FIG. 8, the processor, at operation 806, may transmit a signal for communicating the complexity prediction for display on a user interface.

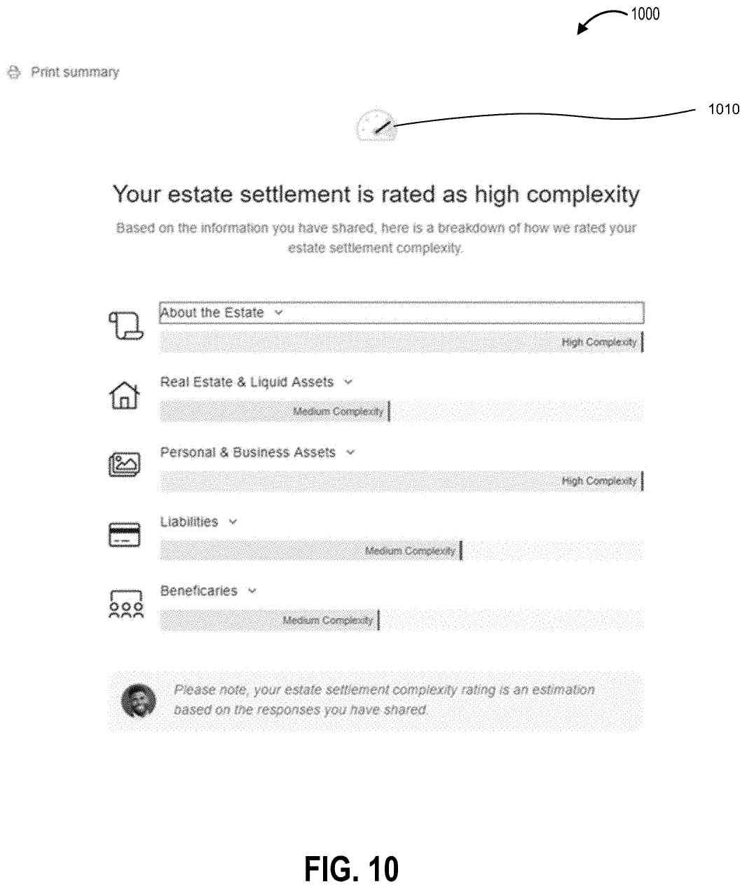

To illustrate, reference is made to FIG. 10, which illustrates a graphical user interface 1000, in accordance with an embodiment of the present disclosure. The graphical user interface 1000 may include one or more indications of the determined complexity prediction for an estate settlement. For example, based on the received resource attributes (e.g., at operation 802), the processor, at operation 804, may have determined that the complexity prediction based on an allocation model is “high complexity”. The processor, at operation 806, may provide the graphical user interface for communicating that the overall estate settlement complexity is “high”.

In some embodiments, graphical user interface elements 1010 may dynamically appear based on the predicted complexity prediction. For example, in FIG. 10, the estate settlement is predicted to be “complex”, and a dial-icon may have an indicator needle pointing near an extreme position to indicate that the estate settlement is predicted to be complex.

To provide more granular data associated with the estate settlement, the processor, at operation 806, may provide the graphical user interface for communicating the complexity of one or more sub-categories based on the received resource attributes associated with the estate settlement. In FIG. 10, the “real estate and liquid assets” category may be rated as being “medium complexity”, and the “personal and business assets” category may be rated as being “high complexity”.

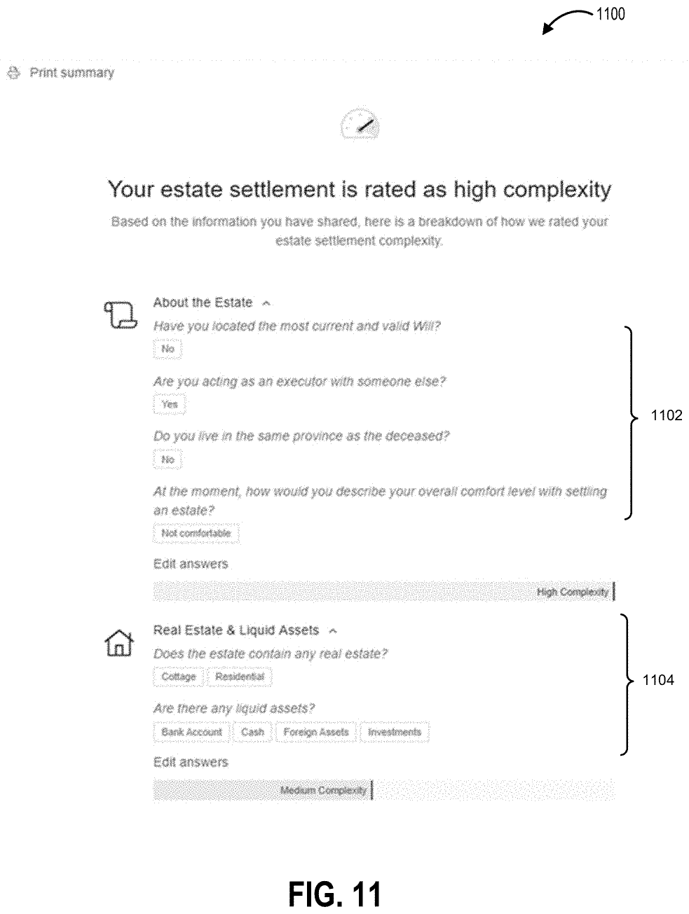

In some scenarios, it may be beneficial to provide further indications of what resource attributes may have contributed to the complexity prediction for the proposed estate settlement. To illustrate, reference is made to FIG. 11, which illustrates a graphical user interface 1100, in accordance with an embodiment of the present disclosure. The graphical user interface 1100 may include a summary 1102 of the previously received resource attributes associated with the “subject estate”, and may include a summary 1104 of the previously received resource attributes associated with “real estate and liquid assets”, thereby providing the executor user with an opportunity to update or alter resource attribute values for re-determining the complexity prediction of the estate settlement.

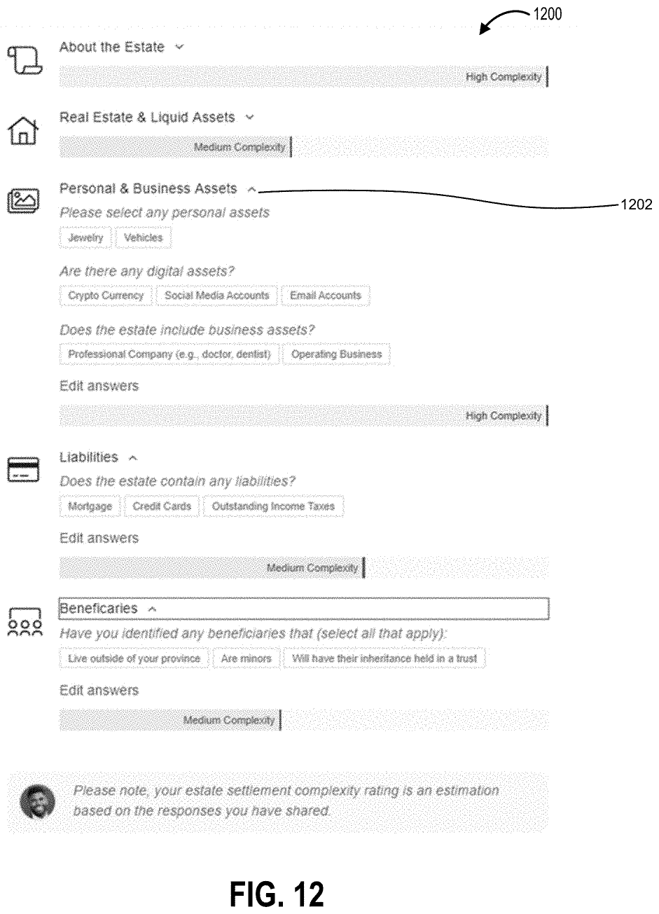

FIG. 12 illustrates a graphical user interface 1200, in accordance with an embodiment of the present disclosure. The graphical user interface 1200 illustrates further examples of summary sections for displaying previously received resource attributes associated with “personal and business assets”, “liabilities”, and “beneficiaries”. In some embodiments, the summary sections may be generated or displayed based on received user input at user interface elements 1202 (e.g., chevron shaped, pull down menu icons, or the like).

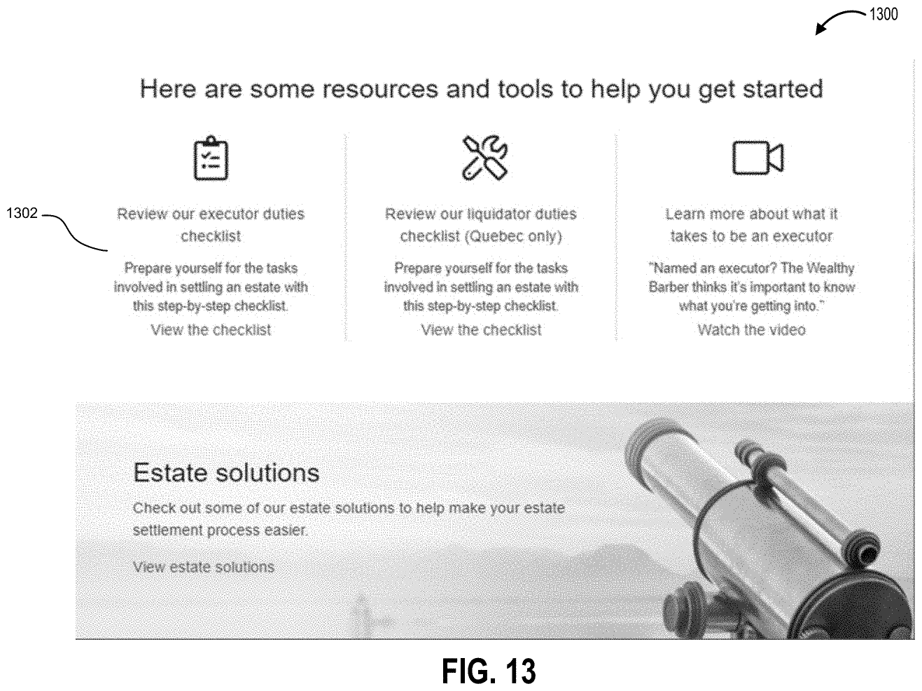

FIG. 13 illustrates a graphical user interface 1300, in accordance with an embodiment of the present disclosure. The graphical user interface 1300 may be transmitted by the system 100 and may be displayed at the client device 130 for providing the executor user with further interactive resources associated with the system 100. For example, the graphical user interface 1300 may include a user interface element 1302 for interacting with further features provided by the system 100. For example, the user interface element 1302 may activate an “executor duties checklist” for providing guidance on recommended tasks for settling the proposed estate. In some examples, the user interface elements may activate communication channels such that the executor user associated with the client device 130 may communicate with a service provider user associated with the service provider device 160. The service provider device 160 may retrieve at least resource attributes associated with the proposed estate settlement, and may be configured to provide estate administration services to the executor user associated with the client device 130.

In some scenarios, the client device 130 associated with the executor user may have a limited display surface area (e.g., define screen size/space) for displaying user interfaces associated with resource allocation operations (e.g., estate settlement guidance). It may be beneficial to provide systems and methods for generating dynamic user interfaces based on data sets representing estates, such that the generated user interfaces include pertinent user interface elements for the executor user.

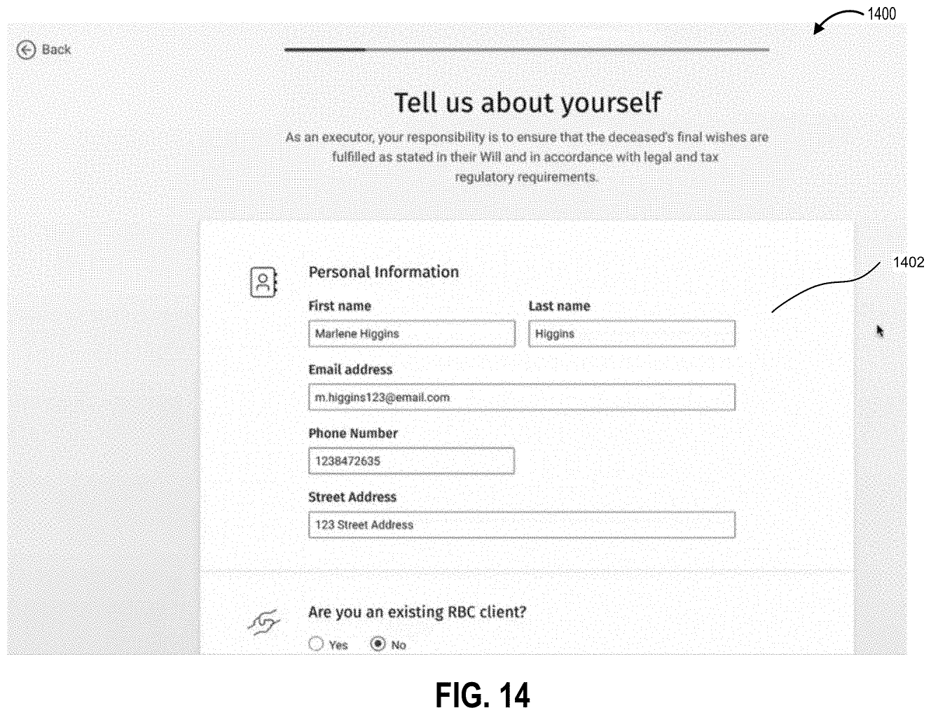

Reference is made to FIG. 14, which illustrates a graphical user interface 1400, in accordance with an embodiment of the present disclosure. The graphical user interface 1400 may be transmitted by the system 100 (FIG. 1) and may be displayed at the client device 130 for providing the executor user with interactive resources associated with operations associated with an administrative framework (e.g., estate settlement, among other examples). The graphical user interface 1400 may include user interface elements, such as text-based input fields, selection interface elements, or other interface elements for receiving executor attributes 1402. Executor attributes 1402 may be included in executor data sets for identifying the executor user.

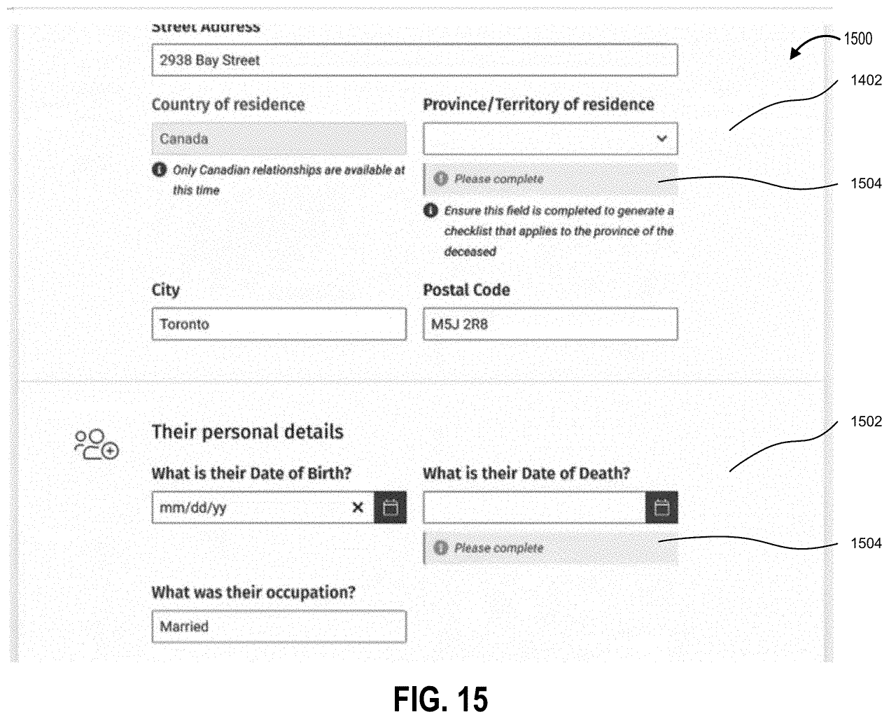

FIG. 15 illustrates a graphical user interface 1500 , in accordance with an embodiment of the present disclosure. The graphical user interface 1500 may further include user interface elements for receiving executor attributes 1402 and for receiving deceased user attributes 1502. In FIG. 15, the dynamic graphical user interface 1500 may include interface elements 1504 identifying for the executor user that particular data fields are required data fields. It may be beneficial to provide interface elements 1504 for representing required data fields, such that the system may conduct downstream operations for identifying complexity predictions or downstream user interfaces for limited display interface surface areas.

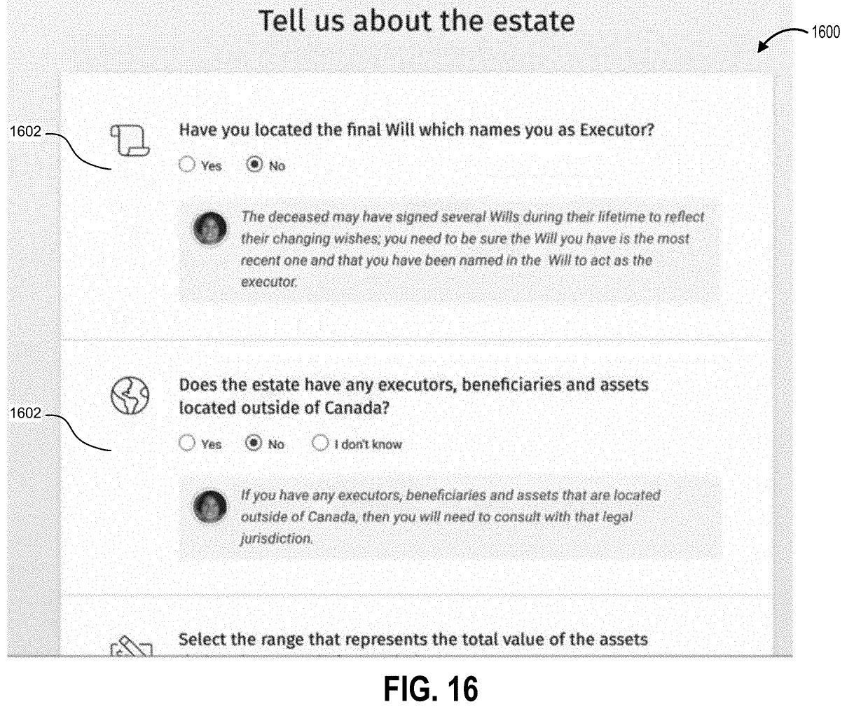

FIG. 16 illustrates a graphical user interface 1600, in accordance with an embodiment of the present disclosure. The graphical user interface 1600 includes user interface elements 1602 for receiving resource attributes. In some embodiments, the client device 130 may receive user input associated with the resource attributes for generating data sets representing an estate, and the client device 130 may transmit the data sets to the system 100 for downstream estate settlement operations.

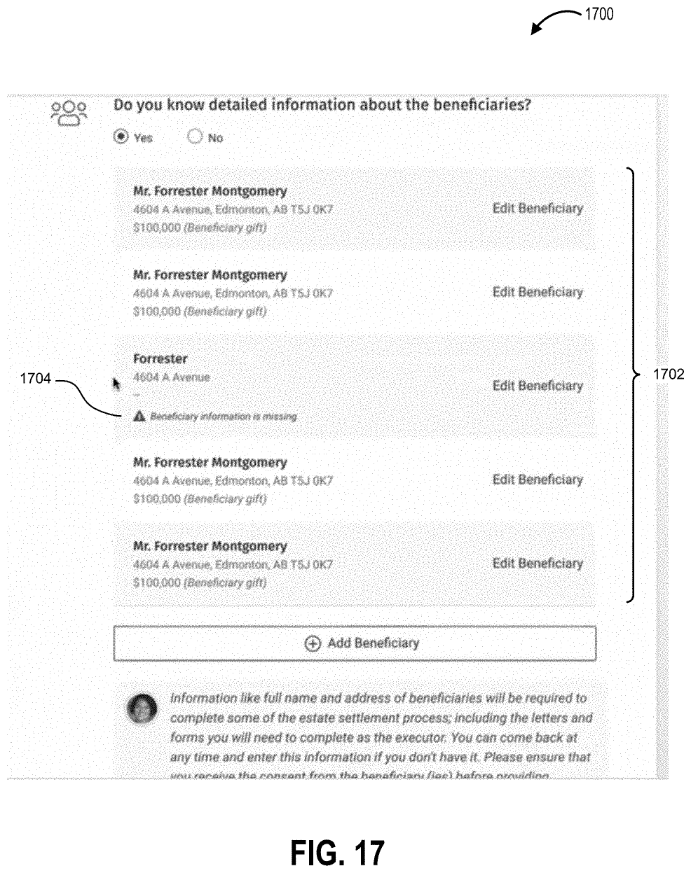

FIG. 17 illustrates a graphical user interface 1700, in accordance with an embodiment of the present disclosure. The graphical user interface 1700 includes user interface elements 1702 for receiving resource attributes associated with beneficiary users. For example, the user interface elements 1702 may be configured to receive demographic data sets associated with the beneficiary users, and may be configured to receive targeted resource allocation data associated with the beneficiary users.

The user interface 1700 may include targeted interface elements 1704 for identifying data fields associated with resource attributes that may be pertinent to downstream operations for at least one of generating complexity predictions or generating targeted graphical user interfaces for display on restricted size display devices of the computing device 130. For example, the targeted interface elements 1704 may be associated with designated required resource attributes for determining downstream operations for providing estate settlement guidance to the executor user. In some embodiments, the targeted interface elements 1704 may be associated with required resource attributes having relatively large influence on a complexity prediction of a particular estate settlement.

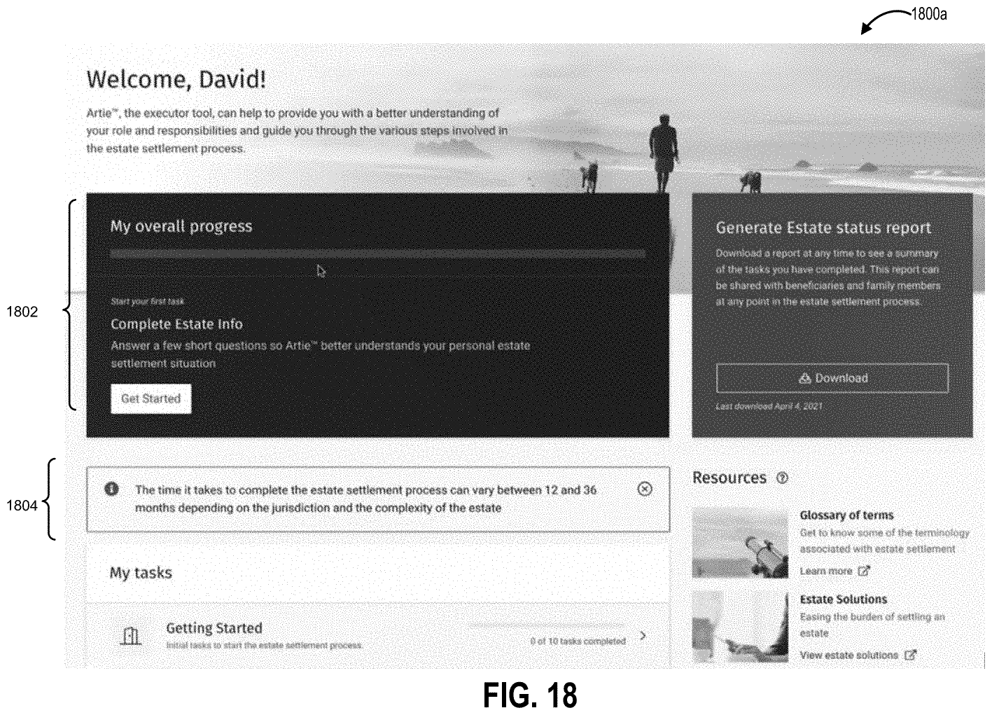

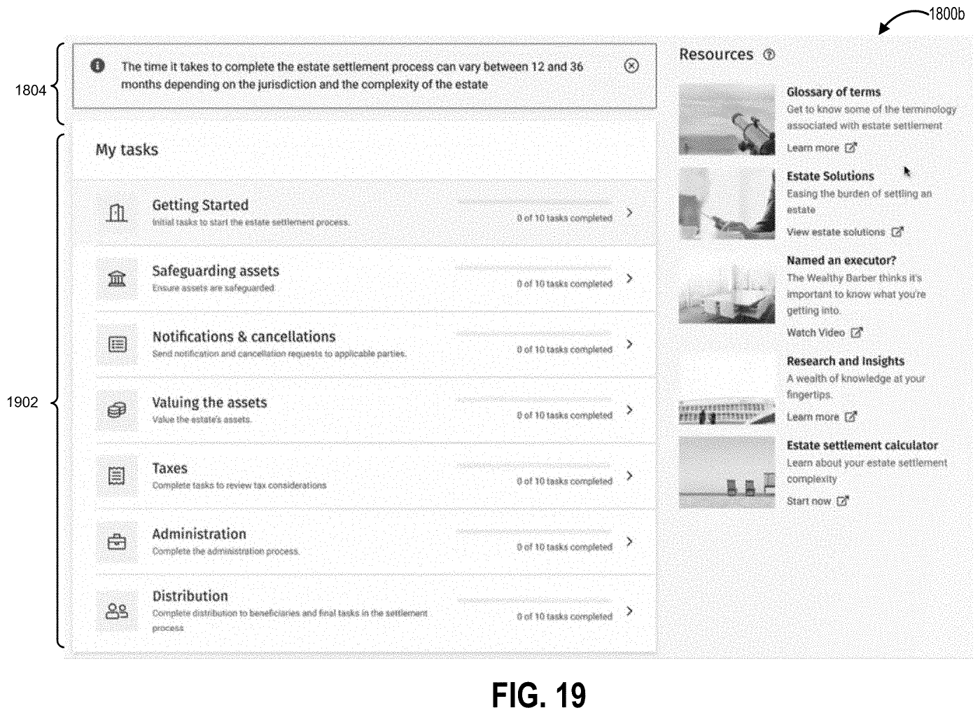

FIGS. 18 and 19 represent graphical user interfaces 1800a, 1800b, in accordance with embodiments of the present disclosure.

The graphical user interface 1800a may be a dashboard user interface for representing summary information based on data sets representing the estate. Because executor users associated with the client device 130 (FIG. 1) may be interfacing with a display device (e.g., a touchscreen device, among other types of input devices) having a finite display surface area, it may be beneficial to provide a dashboard user interface having “bespoke” interface elements based on prior received resource attributes or based on complexity prediction values.

In FIG. 18, the graphical user interface 1800a includes a dynamic progress indicator 1802 representing an overall progress of the estate settlement based on data sets representing the estate settlement. The graphical user interface 1800 may include a duration prediction indicator 1804 for representing an expected or estimated duration of time for the subject estate settlement. The duration prediction indicator 1804 may be based on prior received resource attributes or a complexity prediction values. For example, resource attributes or complexity prediction values associated with relatively complicated estate settlements may be associated with duration prediction indicators 1804 having a longer time estimate.

The graphical user interface 1800b shown in FIG. 19 provides a series of user interface elements 1902 representing granular or discrete tasks for settling the subject estate. In some embodiments, the series of user interface elements 1902 may be a selected subset of a global set of possible user interface elements representing all possible actions for settling any possible estate.

To reduce the volume of user interface elements that may be displayed at the client device 130 (FIG. 1) for the executor user, embodiments of the system may be configured to identify a subset list of discrete tasks and associated complexity predictions for identifying an estimated time duration. Such generation of subset lists and associated complexity predictions represent operations for dynamically generating user interfaces for rendering on a limited surface area display of the client 130. Accordingly, the executor user may have access to pertinent resource attributes and associated interface elements associated with possible tasks or actions for the particular estate settlement.

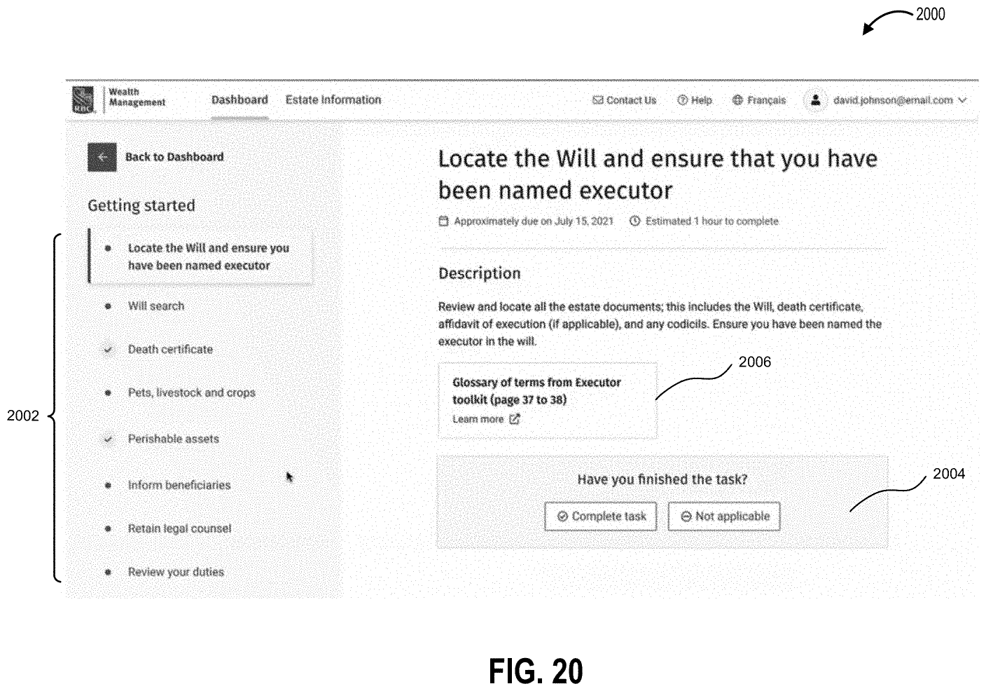

FIG. 20 illustrates a graphical user interface 2000, in accordance with an embodiment of the present disclosure. The graphical user interface 2000 may include a subset listing 2002 of representative tasks or actions required for the particular estate settlement. Because it may be untenable to generate and display user interface elements representing all possible tasks or actions of an estate settlement governed by an administrative framework, it may be beneficial for the system to be configured to enumerate a subset of user interface elements representing tasks or actions that are pertinent to the subject estate.

For example, user interface elements representing actions associated with perishable assets may be shown in scenarios where a deceased user may have a collection of perishable assets (e.g., wine collections, prized agriculture, farms, among other examples). In other examples, these user interface elements representing perishable assets may not be shown for other deceased users, thereby focusing the display interface on user interface elements pertinent to the subject estate.

The graphical user interface 2000 may include a feedback interface element 2004 for receiving executor user input associated with whether a particular action or task has been completed. The graphical user interface 2000 may include other feedback interface elements 2006 for providing guidance to the executor user, where such feedback interface elements 2006 may be correlated with prior generated complexity prediction values. That is, suggested tasks or actions having a relatively greater complexity prediction value may result in the graphical user interface 2000 having particular resources selectable by the feedback user interface elements 2006 (e.g., a PDF form or document opened on a subsequent screen for providing further guidance to the executor user).

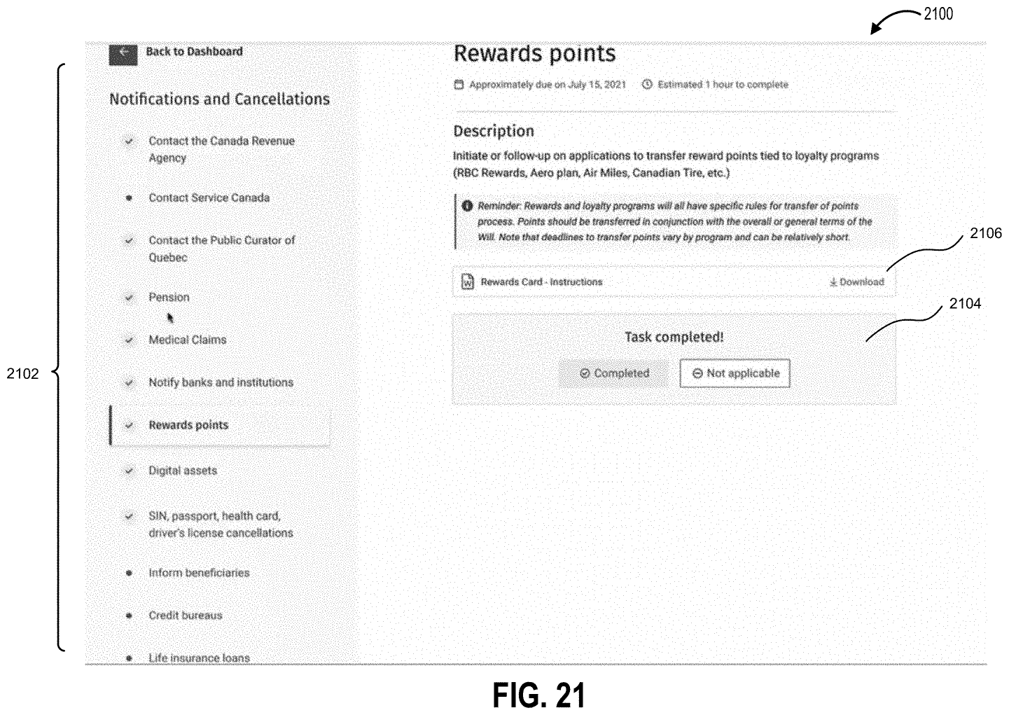

FIG. 21 illustrates a graphical user interface 2100, in accordance with an embodiment of the present disclosure. The graphical user interface 2100 includes a subset listing 2102 of representative tasks or actions required for the particular estate settlement. In the example illustrated in FIG. 21, a representative task of allocating a deceased user's reward points is selected, and the graphical user interface 2100 may dynamically provide feedback interface elements 2106 for providing targeted guidance to the executor user on how to allocate the reward point assets to one or more beneficiary users. In some examples, the graphical user interface 2100 may include a feedback interface element 2104 for receiving executor user input identifying that the particular task associated with reward points has been completed.

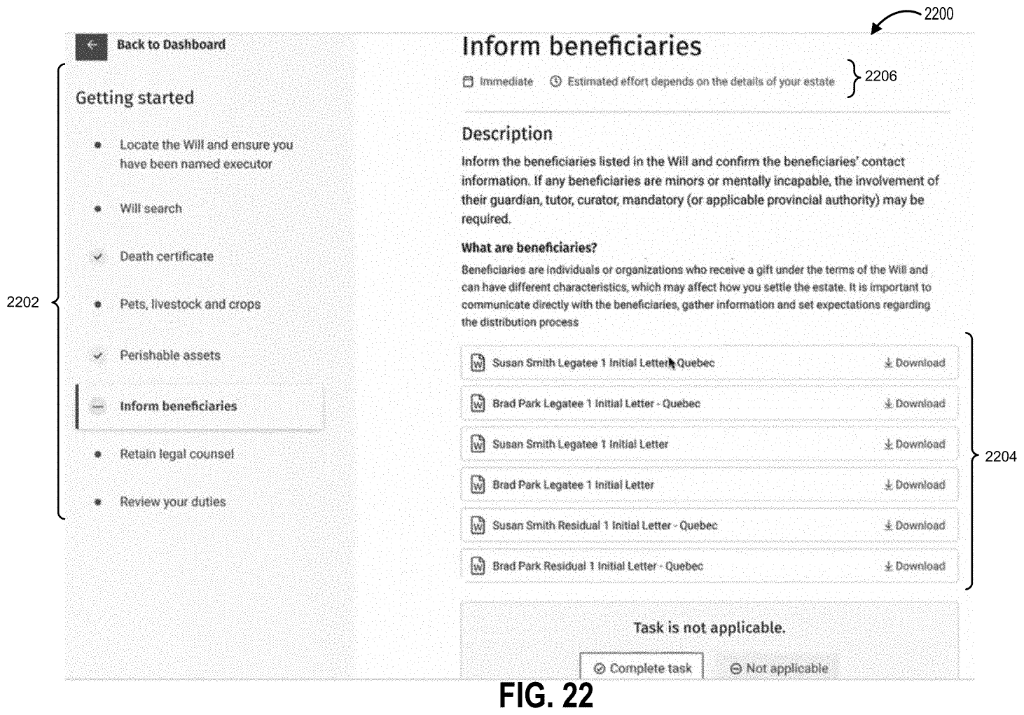

FIG. 22 illustrates a graphical user interface 2200, in accordance with embodiments of the present disclosure. The graphical user interface 2200 includes a subset listing 2202 of representative tasks or actions for a particular estate settlement. In FIG. 22, the example action includes informing beneficiary users of a planned resource allocation. In some scenarios, there may be particular administrative rules associated with providing notification to beneficiaries prior to allocation of such assets. Such administrative rules may vary over time and may vary based on the geographical location of the respective beneficiary users.

In some embodiments, one or more user interface elements are shown representing dynamically generated forms or correspondence for transmitting to beneficiary users. In some embodiments, the system 100 may be configured to generate the forms or correspondence for the respective beneficiary users based on resource attributes received at user interfaces associated with data set generation. For example, the resource attributes may have been received at user interfaces illustrated in FIG. 2 to 7 or 17, among other example user interfaces.

In some embodiments, the graphical user interface 2200 may include feedback interface elements 2206 for providing the executor user with guidance on suggested timing of the representative task or action or the anticipated effort required for attending to the representative task or action (e.g., informing beneficiaries is illustrated in FIG. 22). In some embodiments, the feedback interface elements 2206 may be based on prior determined complexity prediction values or based on resource attributes received via executor user inputs. For example, the feedback interface elements 2206 may provide a representation of an anticipated time duration required for allocating resources (e.g., distributing estate assets to beneficiaries via a series of steps) or an estimated effort indication associated with the allocation of said resources.

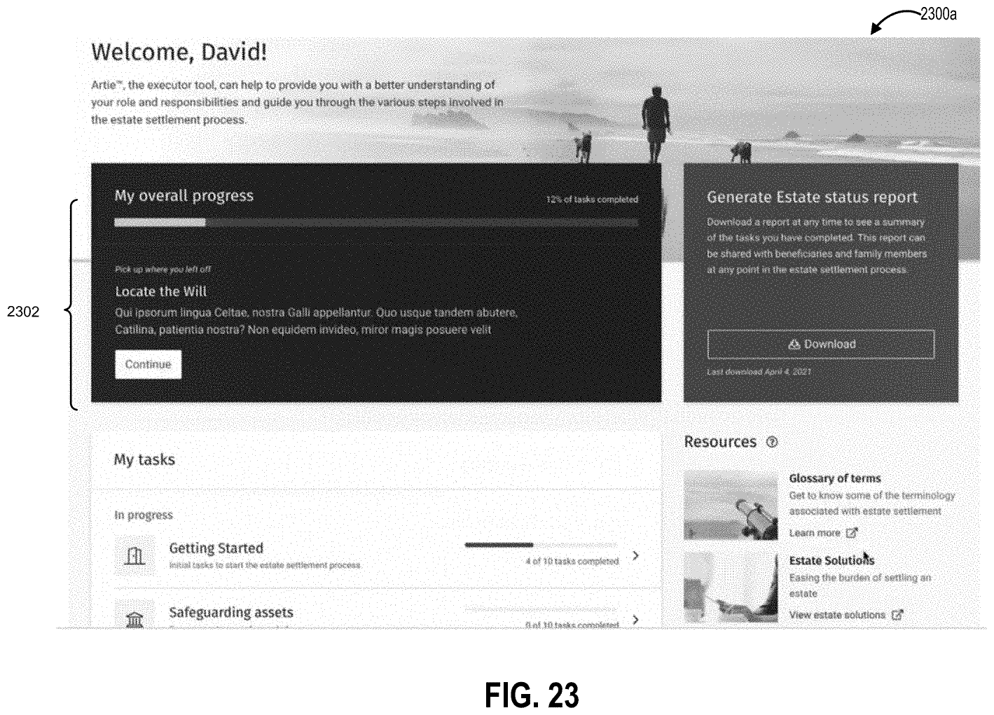

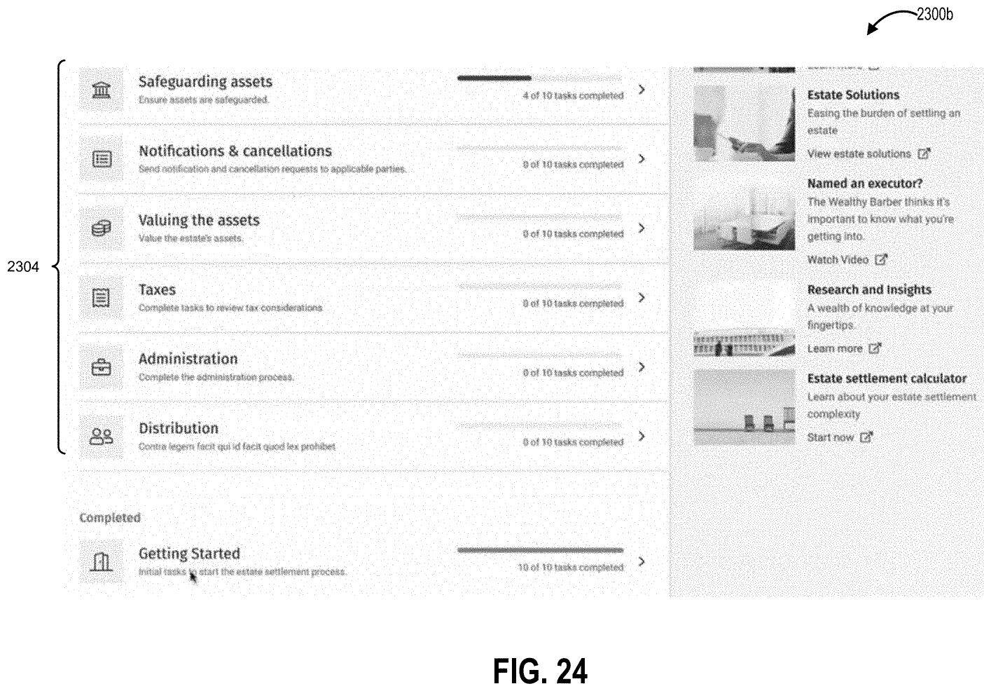

Reference is made to FIGS. 23 and 24, which illustrate graphical user interfaces 2300a, 2300b, in accordance with embodiments of the present disclosure. The graphical user interfaces 2300, 2300b may correspond to the graphical user interface 1800 illustrated in FIGS. 18 and 19 and at a later point in time. In FIGS. 23 and 24, updated user interface elements may represent progress associated with allocating one or more resources to a user identifier. For example, in FIG. 23, the dynamic progress indicator 2302 may be updated to represent the overall progress of the estate settlement based on a series of user inputs representing attributes associated with resources of a resource pool. The one or more user inputs may represent actions or tasks that may already be undertaken or completed. As a successive series of user inputs are received, the system 100 or the client device 130 may generate updates to user interface elements 2304 for respective actions.

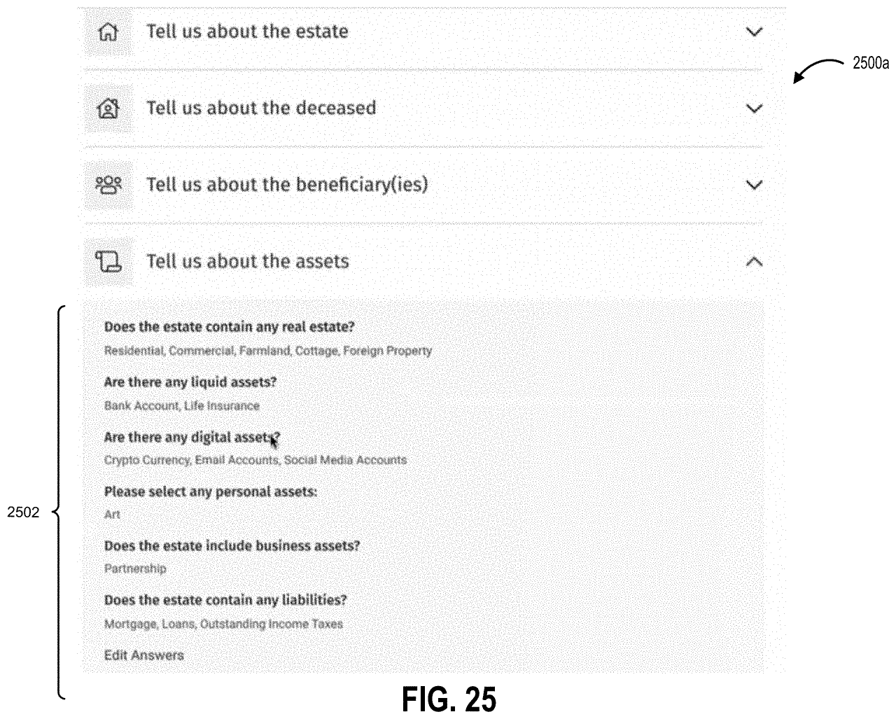

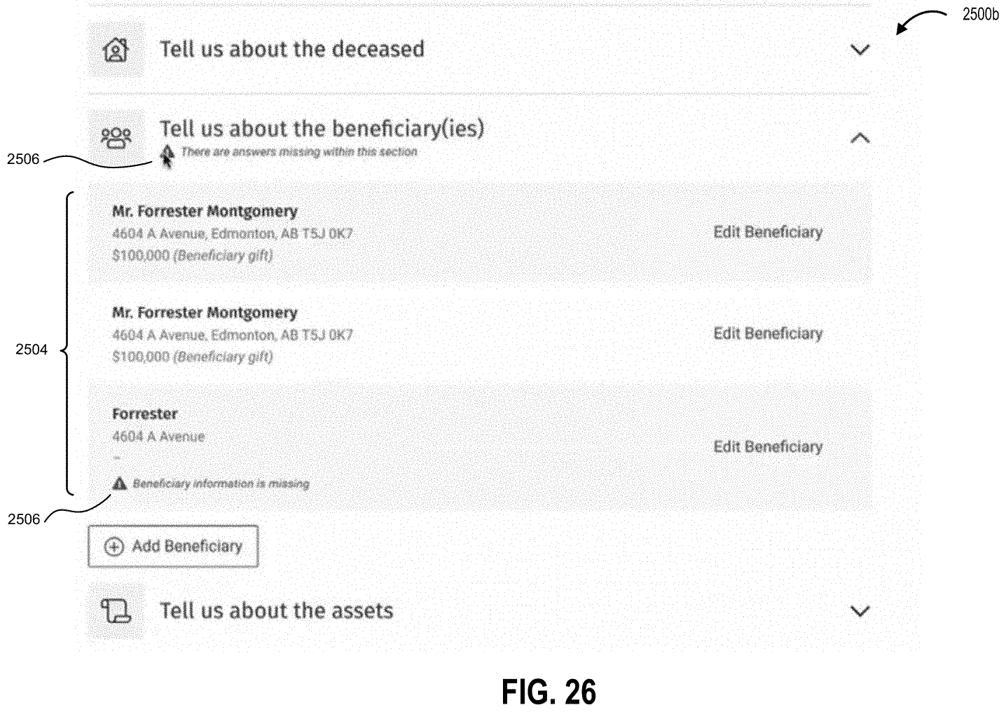

FIGS. 25 and 26 illustrate graphical user interfaces 2500a, 2500b, in accordance with embodiments of the present disclosure. The graphical user interfaces 2500a, 2500b provide user interface elements for summarizing one or more attributes associated with resources of a resource pool. For example, one or more attributes associated with resources may include a listing of types of resources in the resource pool (e.g., bank accounts, life insurance policies, art, crypto currency, social media accounts, among examples).

In some embodiments, one or more attributes associated with resources may include a user interface elements 2504 associated with a listing of beneficiary entities associated with the resources to be allocated. In FIG. 26, the user interface elements 2504 may provide a listing that “Mr. Forrester Montgomery” is a beneficiary of a quantity of monetary funds from the estate.

In some embodiments, the user interface elements 2504 may include representations of required receipt of user input prior to generating the update to the user interface element based on at least one action sequence for the resource pool. For example, in FIG. 26, the user interface 2600a may include one or more user interface elements 2506 for identifying missing attribute data associated with a resource pool.

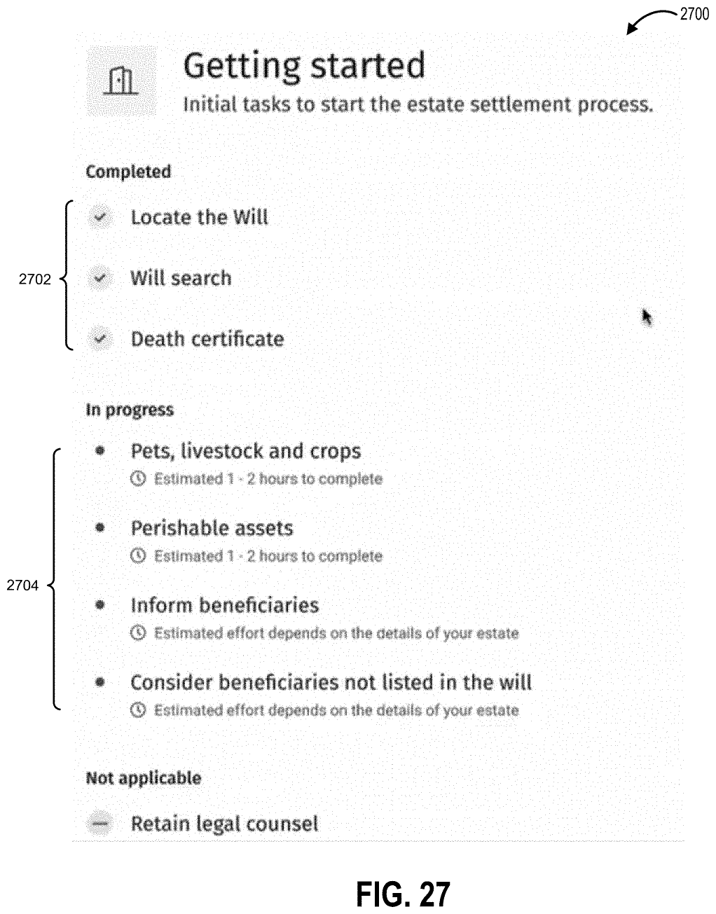

FIG. 27 illustrates a graphical user interface 2700, in accordance with an embodiment of the present disclosure. The graphical user interface 2700 may include a plurality of user interface elements 2702 representing completed operations associated with allocating one or more resources to a user identifier (e.g., finished locating a will and obtaining a death certificate associated with estate settlement operations).

In some embodiments, the graphical user interface 2700 may include one or more user interface elements 2704 representing allocation complexity for respective resources relative to other resources of the resource pool. For example, in FIG. 27, user interface elements 2704 may provide an estimated time duration required for addressing perishable estate assets, estimated time duration required for operations to provide notice to relevant beneficiaries, and estimated time duration associated with beneficiaries who may not be listed in a will. In some embodiments, the estimated time duration may be correlated with a complexity prediction generated based on attributes associated with the resource pool. In some embodiments, the complexity prediction may be based on historical data sets associated with a time duration required for prior executors who had to address or distribute perishable assets, or allocate pets, livestock, and crops to designated beneficiaries.

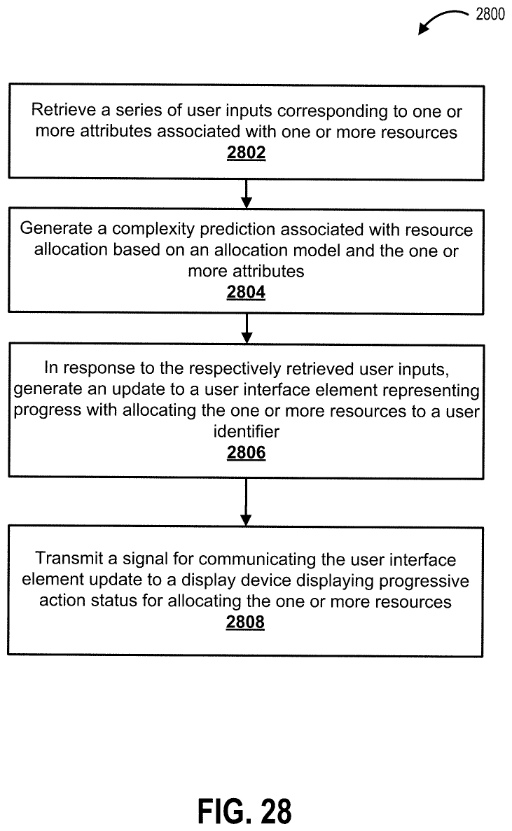

Reference is made to FIG. 28, which illustrates a flowchart of a method 2800 of dynamic generation of successive user interfaces, in accordance with embodiments of the present disclosure. The method 2800 may be conducted by the processor 102 of the system 100 (FIG. 1). Processor-executable instructions may be stored in the memory 106 and may be associated with the resource allocation application 112 or other processor-executable applications not illustrated in FIG. 1. The method 2800 may include operations such as data retrievals, data manipulations, data storage, or other operations, and may include computer-executable operations.

In some embodiments, the method 2800 may be conducted by a processor of the client device 130 (FIG. 1) or other computing devices associated with the system 100.

For ease of exposition, embodiments of the method 2800 may be described in the context of generating user interfaces associated with estate settlements. Estate settlements may include a series of operations for allocating resources (of a resource pool) to one or more beneficiary users. The resource pool may be one or a number of assets, which may include digital assets, monetary assets, real estate assets, social media assets, among examples. In some embodiments, estate settlements may include a series of operations for transferring accounts or closing accounts associated with a beneficiary user. In some embodiments, such estate settlement operations may correspond with attributes, such as the type of operation, type of asset, physical location of beneficiary users, physical location of executor user, among other examples.

At operation 2802, the processor may retrieve a series of user inputs corresponding to one or more attributes associated with resources of a resource pool. The resource pool may include a plurality of assets of a deceased users, and resources of the resource pool may be distributed to beneficiary users (e.g., associated with beneficiary user identifiers).

In some embodiments, the series of user inputs may represent a series of user inputs received by the processor over time. For example, the user inputs may represent data sets generated based on input of information associated with the executor user, with the beneficiary users, with assets or resources in the resource pool, among other example information inputs. In some scenarios, the information input may represent attributes associated with discrete resources of the resource pool.

In some embodiments, the attributes associated with the resource pool may be integral to generating complexity predictions associated with allocating resources to one or more beneficiary user identifiers. For example, attributes of foreign-located assets (e.g., owned real estate located in another country) may be associated with a relatively higher complexity prediction value as compared to attributes of monetary assets that may be accessible within a same country of the executor user. In another example, the attributes of identified beneficiary users located in another province or state as compared to the executor user may be associated with a relatively higher complexity prediction value as compared to attributes associated with identified beneficiary users domiciled within a similar geographical region as the executor user.

In some embodiments, the complexity predictions may be based on historical data sets of prior executors conducting operations for allocating resources to beneficiary users having similar attributes or circumstances.

At operation 2804, the processor may generate a complexity prediction associated with resource allocation based on an allocation model and the one or more attributes. The allocation model may be defined by complexity scores associated with respective attributes. Example complexity scores may be based on basis point value mappings illustrated in Table 1.

Other methods for generating the complexity prediction may be contemplated. In some embodiments, the complexity prediction may be based on machine learning operations configured to weigh complexity predictions based on moving trends over time. For example, at a first point in time, a complexity prediction associated with transferring cryptocurrency assets may be relatively high, whereas the complexity prediction may decrease in value over time as new regulatory frameworks are enacted to address the nature of transferring cryptocurrency assets.

As will be described herein, user interface element updates may be based on the complexity prediction, thereby dynamically generating successive user interfaces.

In response to the respectively retrieved user inputs, at operation 2806, the processor may generate an update to a user interface element representing progress with allocating the one or more resources to a user identifier. The at least one user interface element may be based on the generated complexity prediction.

For example, referring again to FIG. 22, the feedback interface elements 2206 may be updated based on the generated complexity prediction for providing an indication on an estimated time duration for conducting operations associated with a resource allocation operation. For instance, a complexity prediction beyond a threshold value (e.g., relatively high) may be associated with a higher time duration estimation, whereas a complexity prediction that does not meet a threshold value (e.g., relatively low) may be associated with a lower time duration estimation.

In another example, the user interface elements may be updated based on the nature of assets to be allocated. For example, referring again to FIG. 27, user interface elements may be updated based on assets being perishable or livestock assets, which may require a minimum expected duration of time to address.

At operation 2808, the processor may transmit a signal for communicating the user interface element update to a display device displaying progressive action status for allocating the one or more resources of the resource pool. For example, as user input is retrieved over time, and where the user input provides updates to attributes associated with resources for allocation, user interface elements may be updated to provide an executor user with dynamic guidance on status or downstream operations for allocation resources of a resource pool to one or more beneficiaries associated with user identifiers.

In some embodiments, the complexity prediction may indicate that a series of operations for allocating a particular resource type may be highly complex. In the present scenario, the system may determine that an ordinary-skilled executor user may not be able to adeptly undertake the series of operations for allocating the particular resource. For example, disposing of foreign-located real estate assets may require numerous operations involving foreign-agents, foreign-professionals (e.g., tax specialists), among other operations involving foreign-specialists. Accordingly, the processor may generate a distinguishable set of user interface elements for identifying a suggested set of operations for allocating the identified resources. In some examples, the distinguishable set of user interface elements may include user interface elements for transmitting a signal to a computing device associated with a service provider with a notification of the identified highly complex estate settlement operations.

In the above-described example, user interface elements may be updated based on the nature of resources to be allocated. That is, when proposed allocation of resources may involve non-standard resources that may not be within the aptitude of an ordinary executor user, the processor may update user interface elements for providing guidance on engaging a service provider (e.g., estates trustee) to assist with complex disposition or allocation of assets.

In some embodiments, the complexity prediction may indicate that the series of operations for allocating a particular resource type may be of moderate complexity. In the present example, the system may determine that the ordinary-skilled executor may be adept at conducting relatively routine administrative tasks. The processor may generate user interface element updates for providing “do-it-yourself” guidance to executor users for disposing of or allocating said resources of the resource pool (e.g., estate assets).

In some embodiments, a user interface element update may represent a required receipt of user input prior to generating the update to the user interface element based on at least one action sequence for the resource pool. For example, referring again to FIG. 26, the processor may generate one or more user interface elements 2506 for identifying missing attribute data associated with a resource pool that may be required for identifying a complexity prediction to inform updates to user interface elements.

In some embodiments, the user interface elements may include graphical elements representing predicted time duration for allocation of the resources of the resource pool. For example, referring again to FIG. 22, the feedback user interface elements 2206 may be configured to provide the executor user with guidance on suggested timing of the representative task or action, or an anticipated effort required for attending to the representative task or action.

In some embodiments, the user interface elements may include graphical elements identifying allocation complexity for respective resources relative to other resources of the resource pool. For example, referring again to FIG. 27, the user interface elements 2704 representing allocation complexity for respective resources may provide an indication relative to other resources of the resource pool.

In some embodiments, the processor may generate or transmit one or more signals to a computing device associated with a service provider user (e.g., estates trust advisor) in response to identifying that a complexity prediction may be greater than a threshold value (e.g., suggesting a relatively highly complex disposition of estate assets). By providing a signal to a service provider user, embodiments of systems and methods described herein may be configured to supplement “do-it-yourself” estate executor users with guidance from professional users adept with allocating or disposing of resources or assets identified as being highly complex.

In some embodiments, the processor may be configured to pre-populate user interfaces based on the retrieved series of user inputs. For example, referring again to FIG. 22, the processor may update user interface elements 2204 representing dynamically generated forms or correspondence letters for transmitting to other parties. The dynamically generated forms may be based on attributes received based on user inputs. For example, attributes may be associated with details of beneficiary users, details of nature of assets (e.g., monetary amounts, etc.), or details associated with local rules or guidelines for asset allocation (e.g., estates rules in Ontario versus Quebec).

In some embodiments, the user interface element may include a listing of interface elements representing contingent user actions for allocating the resource pool. For example, referring again to FIG. 20, the user interface element may be a feedback interface element 2004 representing whether a task has been completed or not. In some embodiments, such feedback interface elements may be precursors or may be contingent user inputs required prior to downstream user interface updates of the system.

In some embodiments, resource pools may include example assets such as real estate resources, monetary resources, digital assets, liabilities, social media assets, among other examples.

In some embodiments, the allocation model may be trained based on a series of progressive trends associated with resource allocation of resource pool assets. For example, at a given point in time, disposition or allocation of cryptocurrency assets may be associated with a relatively high complexity score value, at least, because regulatory frameworks for cryptocurrency assets may be relatively new. Over time, as regulatory frameworks for addressing transfers of cryptocurrency assets become more mainstream and more common, the allocation model may be updated based on machine learning operations such that a disposition or allocation of cryptocurrency assets may be associated with a moderate or lower complexity score value.

In some embodiments, the allocation model may be trained based on historical data sets representing prior resource pool allocations. For example, the trained allocation model may generate complexity predictions based on relative ease experienced by prior executor users tasked with disposing of or transferring resources of an estate (e.g., a similar estate settlement).

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A system for dynamic generation of successive user interfaces comprising:
a processor; and
a memory coupled to the processor and storing processor-executable instructions that, when executed, configure the processor to:
retrieve a series of user inputs corresponding to one or more attributes associated with one or more resources;
generate a complexity prediction associated with resource allocation based on an allocation model and the one or more attributes, the allocation model defined by complexity scores associated with respective attributes;
in response to the respectively retrieved user inputs, generate an update to a user interface element representing progress with allocating the one or more resources to a user identifier, wherein at least one user interface element is based on the generated complexity prediction; and
transmit a signal for communicating the user interface element update to a display device displaying progressive action status for allocating the one or more resources.

2. The system of claim 1, wherein the user interface element representing required receipt of user input prior to generating the update to the user interface element based on at least one action sequence for the resource pool.

3. The system of claim 1, wherein the user interface element includes graphical elements representing predicted time duration for allocation of the resources of the resource pool.

4. The system of claim 1, wherein the user interface element includes graphical elements identifying allocation complexity for respective resources relative to other resources of the resource pool.

5. The system of claim 1, wherein the memory includes processor-executable instructions that configure the processor to:
determine that a proposed resource allocation is associated with a complexity prediction meeting a threshold value; and
generate a first set of user interface elements for providing guiding operations for allocating the one or more resources.

6. The system of claim 5, wherein in response to determining that the proposed resource allocation is associated with a complexity prediction not meeting a threshold value, generating a second set of user interface elements for identifying a second set of operations for allocating the proposed resource allocation.

7. The system of claim 1, wherein the memory includes processor-executable instructions that configure the processor to transmit a signal to a computing device associated with a service provider in response to identifying that the complexity prediction is greater than a threshold value.

8. The system of claim 1, wherein the memory includes processor-executable instructions that configure the processor to pre-populate user interfaces based on the retrieved series of user inputs.

9. The system of claim 1, wherein the user interface element includes a listing of interface elements representing contingent user actions for allocating the one or more resources.

10. The system of claim 1, wherein the one or more resources includes at least one of real estate resources, monetary resources, digital assets, and liabilities.

11. The system of claim 1, wherein the allocation model is trained based on a series of progressive trends associated with resource allocation of the one or more resources.

12. The system of claim 1, wherein the allocation model is trained based on historical data sets representing prior resource allocations.

13. A method for dynamic generation of successive user interfaces comprising:
retrieving a series of user inputs corresponding to one or more attributes associated with one or more resources;
generating a complexity prediction associated with resource allocation based on an allocation model and the one or more attributes, the allocation model defined by complexity scores associated with respective attributes;
in response to the respectively retrieved user inputs, generating an update to a user interface element representing progress with allocating the one or more resources to a user identifier, wherein at least one user interface element is based on the generated complexity prediction; and
transmitting a signal for communicating the user interface element update to a display device displaying progressive action status for allocating the one or more resources.

14. The method of claim 13, wherein the user interface element includes graphical elements representing predicted time duration for allocation of the resources of the resource pool.

15. The method of claim 13, wherein the user interface element includes graphical elements identifying allocation complexity for respective resources relative to other resources of the resource pool.

16. The method of claim 13, comprising:
determining that a proposed resource allocation is associated with a complexity prediction meeting a threshold value; and
generating a first set of user interface elements for providing guiding operations for allocating the one or more resources.

17. The method of claim 16, wherein in response to determining that the proposed resource allocation is associated with a complexity prediction not meeting a threshold value, generating a second set of user interface elements for identifying a second set of operations for allocating the proposed resource allocation.

18. The method of claim 13, comprising transmitting a signal to a computing device associated with a service provider in response to identifying that the complexity prediction is greater than a threshold value.

19. The method of claim 13, comprising pre-populating user interfaces based on the retrieved series of user inputs.

20. A non-transitory computer-readable medium having stored thereon machine interpretable instructions which, when executed by a processor, cause the processor to perform a computer implemented method comprising:
retrieving a series of user inputs corresponding to one or more attributes associated with one or more resources;
generating a complexity prediction associated with resource allocation based on an allocation model and the one or more attributes, the allocation model defined by complexity scores associated with respective attributes;
in response to the respectively retrieved user inputs, generating an update to a user interface element representing progress with allocating the one or more resources to a user identifier, wherein at least one user interface element is based on the generated complexity prediction; and
transmitting a signal for communicating the user interface element update to a display device displaying progressive action status for allocating the one or more resources.
